(19) United States
(12) Patent Application Publication
(10) Pub. No.: US 2026/0289927 A1
(43) Pub. Date: Sep. 24, 2026

(54) SYSTEM

(71) Applicant: SoftBank Group Corp., Tokyo (JP)

(72) Inventor: Jumpei FUJINO, Tokyo (JP)

(73) Assignee: SoftBank Group Corp., Tokyo (JP)

(21) Appl. No.: 19/561,640

(22) Filed: Mar. 10, 2026

(30) Foreign Application Priority Data
Mar. 19, 2025 (JP) 2025-044964

(51) Int. Cl. G06T 19/20; G06N 3/0475

(52) U.S. Cl. CPC G06T 19/20; G06N 3/0475

(57) ABSTRACT

A system includes a processor that is configured to: provide an interface for accepting input from a user, analyze the input from the user and generate a prompt for instructing a generative AI model to generate a design, and input the generated prompt into the generative AI model and cause the generative AI model to generate the design.

### CROSS-REFERENCE TO RELATED APPLICATION

This application is based on and claims priority under 35 USC 119 from Japanese Patent Application No. 2025-044964 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional design generation systems using generative AI models require users to directly input technical prompts or detailed design specifications in a format suitable for the underlying models. As a result, users who are unfamiliar with prompt engineering or with the operation of generative AI models face difficulty in obtaining a design that reflects their subjective mood or preferences. In addition, conventional systems do not sufficiently support an interactive workflow in which the user's mood and preference information is automatically analyzed, incorporated into a model prompt, and then iteratively refined based on user feedback. Accordingly, there is a need for a system that allows a user to express design intentions in natural, intuitive terms, such as mood and preferences, and that automatically converts such input into suitable prompts for a generative AI model, generates a corresponding design, and further facilitates user confirmation, modification, and finalization of the design.

### SUMMARY

In order to solve the above-described problems, a system according to one aspect of the present invention comprises a processor, wherein the processor is configured to provide an interface for accepting input from a user, analyze the input from the user and generate a prompt for instructing a generative AI model to generate a design, and input the generated prompt into the generative AI model and cause the generative AI model to generate the design. The processor is further configured to analyze mood information and preference information extracted from the input from the user and generate the prompt for instructing the generative AI model to generate the design reflecting the mood information and the preference information. The processor is also configured to provide an interface for accepting confirmation and modification of the design generated by the generative AI model from the user, and store the design as a final design. By these means, the system enables the user to obtain, without specialized technical knowledge, a design generated by the generative AI model that reflects the user's subjective mood and preferences, and to interactively refine and finalize the design through confirmation and modification using intuitive interfaces.

The term “system” refers to a combination of hardware and software components, including at least one processor and associated memories, storage, and interfaces, configured to execute the processing described in the claims.

The term “processor” refers to one or more central processing units (CPUs), graphics processing units (GPUs), microprocessors, or other processing circuits, including distributed or cloud-based processing resources, that execute instructions to perform the functions described in the claims.

The term “interface” refers to a hardware and/or software module, such as a graphical user interface, web page, application screen, or application programming interface, that enables a user to input information or to confirm or modify a design, and that enables the processor to receive or present such information.

The term “user” refers to any human operator who provides input describing design intentions, mood, or preferences, and who confirms, modifies, or finalizes a design generated by the system.

The term “input” refers to information provided by the user through the interface, including natural language text, selections from predefined options, or other forms of user-provided data expressing design requirements, mood, or preferences.

The term “analyze” refers to processing the input using rule-based logic, statistical methods, machine learning, natural language processing, or other computational techniques to extract, interpret, or classify information relevant to generating a design prompt.

The term “prompt” refers to text data or other structured data generated by the processor and supplied to a generative AI model, the text data or structured data specifying instructions or conditions for generating a design.

The term “generative AI model” refers to a machine learning model, such as a text-to-image model, diffusion model, or other generative model, that generates design data, including image data, in response to a prompt.

The term “design” refers to digital data representing a graphical or visual layout, pattern, or artwork, including but not limited to a T-shirt design, generated by the generative AI model based on the prompt.

The term “mood information” refers to information indicative of the user's emotional state or feelings, such as feeling energetic, calm, cheerful, or subdued, extracted or inferred from the user's input.

The term “preference information” refers to information indicative of the user's tastes, desired styles, colors, patterns, motifs, or other design-related preferences, extracted or inferred from the user's input.

The term “reflecting the mood information and the preference information” refers to causing the generated design to visually express or incorporate elements corresponding to the extracted mood information and preference information, such as color schemes, motifs, or composition styles aligned with the user's mood and preferences.

The term “confirmation” refers to an operation by which the user reviews and optionally approves a design generated by the generative AI model via the interface.

The term “modification” refers to an operation by which the user requests changes to a generated design, including changes to colors, motifs, layout, or other visual elements, through additional input provided via the interface.

The term “store the design as a final design” refers to recording the design, after user confirmation, in a storage medium such as a database or file storage, in association with identifiers or metadata, so that the design can be subsequently retrieved, used, or output as a completed design.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

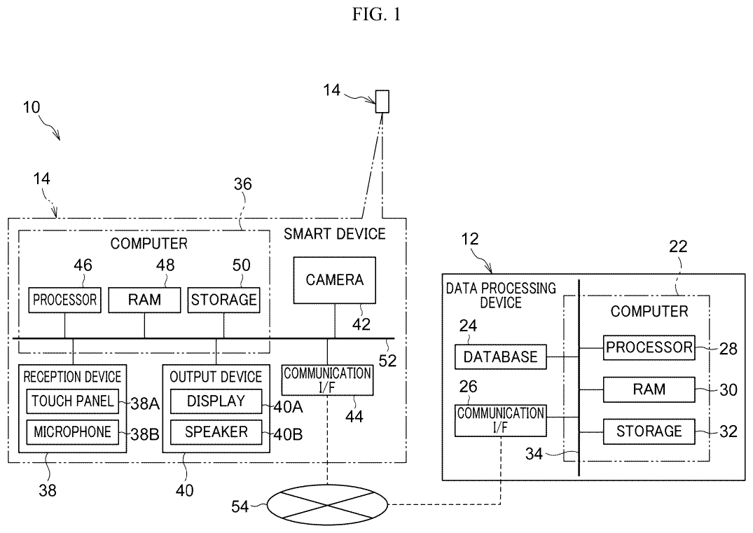

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

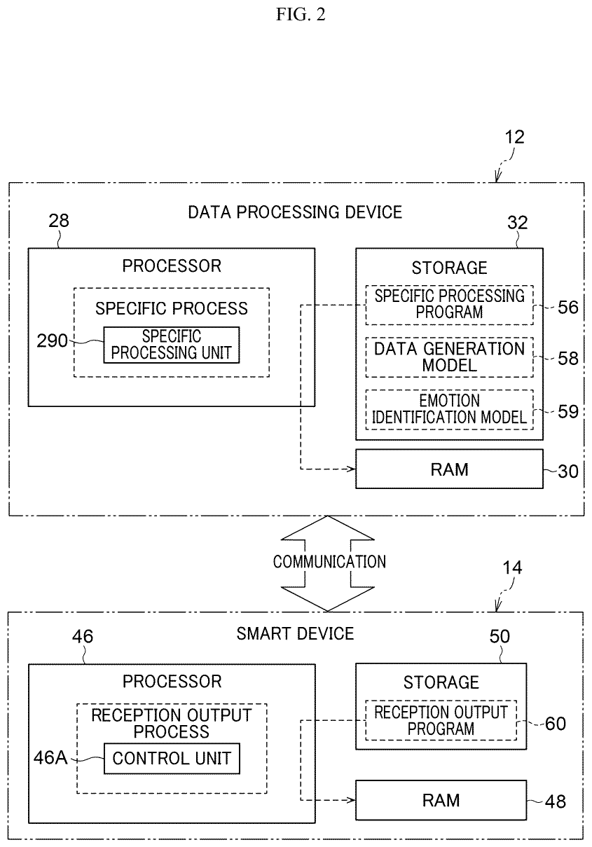

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional design generation systems that rely on generative AI models typically accept user instructions in free-form natural language and forward those instructions directly as prompts to a generative model. Such systems suffer from several technical drawbacks in the context of computer-implemented design generation. First, the systems lack a structured mechanism for extracting and representing user state information, such as emotional conditions, and user preference information, such as desired color tone or subject matter, from the raw text input. As a result, the mapping from user input to a machine-interpretable prompt is ambiguous and unstable, which leads to inconsistent or irrelevant outputs from the generative AI model. This degrades the effectiveness of the computing resources, because the model is often invoked multiple times due to unsatisfactory results, thereby increasing processing time, network traffic, and computational load on servers and accelerators. Second, known systems do not provide an integrated processing flow that iteratively refines prompts based on user feedback using explicit feature information extracted by natural language processing. In many cases, user feedback is handled as another unstructured text input and is not associated with previously extracted features or previously generated prompts. This prevents the system from efficiently converging on a design that matches the user's emotional state and preferences and causes repeated full re-processing of input text, which increases latency and consumes additional processing cycles and memory bandwidth. Third, conventional systems do not systematically associate generated visual composition data with the underlying feature information and prompt sentences in persistent storage. Without this association, the system cannot technically leverage prior interactions to optimize subsequent prompt generation, and cannot support efficient retrieval or reuse of past design results that match similar user states or preferences. This absence of structured association between model inputs and outputs reduces the ability of the computing system to adaptively improve generation quality over time, and limits opportunities for caching, indexing, and other computer-level optimizations.

Accordingly, there is a need for an improved computer-implemented design generation system that (i) performs explicit natural language processing of user inputs to extract structured feature information representing emotional state and preference attributes, (ii) constructs prompt sentences for a generative AI model in a feature-aware and iterative manner based on such structured information, and (iii) associates generated visual compositions with the corresponding feature information and prompt sentences in storage. Such a system can technically improve the efficiency, consistency, and responsiveness of the underlying computer architecture used for design generation.

The specific processing by the specific processing unit 290 of the data processing device 12 in Example 1 is realized by the following means.

The present invention provides a server comprising a processor configured to provide an input/output interface for receiving character information including user state information or user preference information, to analyze the character information by natural language processing to extract feature information indicating an emotional state or a preference attribute of a user, to generate structured information including the feature information, to generate an instruction sentence based on the structured information by template processing or character string processing so as to instruct a generative AI model to generate visual composition data, to convert the instruction sentence into a prompt sentence as request data transmittable to the generative AI model, to transmit the request data to the generative AI model via a communication network, to acquire the visual composition data from the generative AI model, to display the visual composition data to the user via the input/output interface, to receive additional evaluation information or modification request information from the user again as the character information, to repeatedly execute the natural language processing and the generation of the instruction sentence based on updated feature information, and to store, in a storage device, the visual composition data in association with identification information together with the corresponding prompt sentence and the feature information. This enables a computer system to generate designs in a technically improved manner by stabilizing and structuring the transformation from user input to prompt sentence, reducing unnecessary generative model invocations through feature-based iterative refinement, and supporting efficient retrieval and reuse of generated visual compositions linked to explicit feature representations.

The term “processor” refers to a hardware execution unit or a combination of hardware execution units, such as a central processing unit, a graphics processing unit, or a dedicated computation circuit, that is configured to execute instructions and perform arithmetic and logical operations.

The term “information processing apparatus” refers to an electronic apparatus including at least one processor and a memory, and capable of executing a program to process input data and generate output data.

The term “input/output interface” refers to a hardware and/or software component configured to receive information from a user or an external apparatus and to present information to the user or the external apparatus, including, for example, a display device, a pointing device, a keyboard, a touch panel, a microphone, a speaker, or an application programming interface.

The term “character information” refers to data representing natural language content in a textual form, including, for example, a sequence of characters, symbols, or tokens obtained from user input or speech recognition.

The term “user state information” refers to information representing a psychological or emotional condition of a user, such as an energetic mood, a relaxed mood, or a similar affective state, expressed or implied in the character information.

The term “user preference information” refers to information representing a user's desired attributes for a generated result, such as a preferred color tone, style, subject matter, or layout, expressed or implied in the character information.

The term “natural language processing” refers to a computational technique executed by the processor for analyzing and processing human language, including at least one of tokenization, part-of-speech tagging, parsing, sentiment analysis, entity extraction, or classification of text.

The term “feature information” refers to structured information extracted from character information by natural language processing, which represents at least one of an emotional state, a preference attribute, a color tone attribute, or a subject attribute related to a user.

The term “structured information” refers to information represented in a predetermined format, such as a record, a table, or a hierarchical data structure, in which feature information is stored in association with defined fields or keys.

The term “instruction sentence” refers to a natural language sentence generated by the processor based on structured information and configured to instruct a generative AI model to generate visual composition data having attributes corresponding to the feature information.

The term “prompt sentence” refers to an instruction sentence formatted as request data suitable for input to a generative AI model, and used by the generative AI model as a conditioning input to control generation of output data.

The term “template processing” refers to processing in which a processor generates an instruction sentence or a prompt sentence by inserting feature information into predetermined sentence patterns or templates.

The term “character string processing” refers to processing in which a processor manipulates sequences of characters, including concatenation, replacement, formatting, or other operations to construct or modify text.

The term “generative AI model” refers to an artificial intelligence model configured to generate new data, such as images or text, in response to an input prompt or conditioning information, and including, for example, a neural network-based generative model.

The term “request data” refers to data transmitted from the information processing apparatus to the generative AI model via a communication network, and including at least a prompt sentence and optionally additional generation parameters.

The term “communication network” refers to a wired or wireless data transmission infrastructure, such as a local area network, a wide area network, or the Internet, used to exchange data between the information processing apparatus and external systems including a generative AI model.

The term “visual composition data” refers to data representing a visual arrangement, such as an image, a pattern, a layout, or graphical elements, generated by a generative AI model in response to a prompt sentence.

The term “evaluation information” refers to information indicating a user's assessment of generated visual composition data, including, for example, selection information, rating information, or an acceptance or rejection indication.

The term “modification request information” refers to information indicating a user's request to change attributes of generated visual composition data, such as requests to adjust color tone, subject size, complexity, or layout.

The term “storage device” refers to a non-transitory computer-readable medium, such as a semiconductor memory, a magnetic storage medium, or an optical storage medium, configured to store data including visual composition data, prompt sentences, feature information, and identification information.

The term “identification information” refers to data used to uniquely or distinctively identify an item stored in a storage device, such as an identifier, an index, a hash value, or a combination of such elements.

In one embodiment, a server, a terminal, and a user cooperate to realize the claimed system. The server includes at least one processor and a memory, and executes a program that implements natural language processing, feature extraction, prompt sentence generation, communication with a generative AI model, and storage of generated visual composition data. The terminal includes a display, an input device such as a touch panel or keyboard, an audio input device such as a microphone, and a communication interface. The user operates the terminal to provide input and view generated designs.

The server uses general-purpose computing hardware, for example a central processing unit and a main memory executing an operating system, and may additionally use an accelerator such as a graphics processing unit for neural network inference. The server executes application software written in a high-level language, for example a scripting language runtime, a web application framework, and natural language processing libraries. In one example, the server runs a runtime environment capable of executing Python programs, a web framework such as a REST server framework, and natural language processing libraries such as spaCy and NLTK installed on a server operating system such as a Linux distribution.

The server stores data in a relational database management system such as a SQL database.

The terminal uses a web browser or native application framework to render a graphical user interface. For example, the terminal runs a browser such as a standard mobile or desktop browser, or a native mobile application framework such as an application framework for a smartphone operating system. The terminal provides a text input field, a selection control for languages, and optionally a speech input function that performs speech-to-text conversion using a speech recognition service. The terminal sends character information, which is a text representation of a user's natural language input, to the server over a communication network using secure transport protocols.

The user enters natural language content describing the user's current emotional state and design preferences. For example, the user provides sentences such as:

“I feel energetic today, so I want a bright floral design.”

“I want to relax today, so I prefer a design with calm, subdued colors.”

“I want a calm design for a meditation app background, with dark blue and simple geometric patterns.”

The terminal transmits this character information to the server as textual data.

The server receives the character information and stores it in memory as a sequence of characters. The server then performs natural language processing. In one embodiment, the server loads a pre-trained language model via a natural language processing library. The server performs tokenization, part-of-speech tagging, sentence segmentation, and dependency parsing. The server also applies a sentiment or emotion classifier implemented as a neural network to estimate an emotional state label such as “energetic,” “relaxed,” or “neutral.”

The server uses rule-based and statistical algorithms to transform the parsed representation into feature information. For example, the server uses pattern matching on dependency trees and part-of-speech tags to detect phrases indicating mood (e.g., “energetic,” “relax,” “calm”), color tone (e.g., “bright,” “subdued,” “dark blue”), and subject attributes (e.g., “floral design,” “geometric patterns”). The server stores the extracted features in a structured information format, such as a record with fields “mood,” “color_tone,” and “subject.” For the example inputs above, the server may generate structured information such as:
mood: energetic
color_tone: bright
subject: floral
or
mood: relaxed
color_tone: calm, subdued
subject: (unspecified or generic design)
or
mood: calm
color tone: dark blue
subject: simple geometric patterns

The server represents such structured information as a dictionary-like structure or a JSON-like internal object with fixed keys and normalized values. By normalizing the values (e.g., mapping synonyms to canonical labels such as “bright” or “calm”), the server reduces ambiguity and improves reproducibility of subsequent processing.

The server generates an instruction sentence by template processing and character string processing. The server maintains a set of templates that describe generic instructions to a generative AI model, such as:

“Please propose a {color_tone} {subject} design that matches a {mood} mood.” “Please propose a design with {color_tone} colors that matches a {mood} mood.” “Please propose a {mood} design for a {usage} background, using {color_tone} and {subject}.”

The server selects a template based on which feature fields are present. The server inserts feature values into placeholders and performs string concatenation and grammatical adjustments (such as inserting articles or changing pluralization) to generate a natural-sounding instruction sentence. For example, the server generates prompt sentences such as: “Please propose a bright floral design that matches an energetic mood.”

“Please propose a design with calm and subdued colors that matches a relaxed mood.” “Please propose a calm design for a meditation app background, using dark blue and simple geometric patterns.”

The server may further supplement the prompt sentence with constraints about resolution, style, or output format, such as:

“Please propose a bright floral design that matches an energetic mood. Use vivid yellows, pinks, and greens with large, dynamic flower patterns and a playful, modern style. Output as a 1024×1024 seamless pattern suitable for fabric printing.”
or

“Please propose a design with calm and subdued colors that matches a relaxed mood. Use soft blues and grays, minimalistic shapes, and plenty of whitespace. Output as a flat illustration suitable for a smartphone wallpaper.”
or

“Please propose a calm design for a meditation app background, using dark blue and simple geometric patterns. Avoid bright colors, emphasize symmetry, and ensure the design is not distracting. Output as a 1080×1920 background image suitable for mobile apps.”

The server thus constructs a prompt sentence that expresses both emotional context and technical constraints in a form tailored to the generative AI model.

The server or the terminal then provides the prompt sentence to a generative AI model. In one embodiment, the terminal transmits the prompt sentence to an external generative AI service over the communication network. In another embodiment, the server hosts the generative AI model locally. The generative AI model may be a text-to-image generative model implemented as a neural network, such as a diffusion model, a transformer-based model, or a generative adversarial network. For example, the generative AI model may use a text encoder (such as a transformer encoder) to map the prompt sentence into a sequence of embedding vectors, and a diffusion-based decoder to iteratively denoise a latent representation into an image tensor.

In one specific implementation, the generative AI model uses a transformer text encoder that tokenizes the prompt sentence, maps tokens to embeddings, and processes the sequence through multiple layers of self-attention and feed-forward networks to produce contextual embeddings. These embeddings condition a latent diffusion model that starts from random noise in a latent space and applies a parameterized denoising process over a fixed number of steps. At each step, the model performs matrix multiplications with learned weights, applies non-linear activation functions, and uses cross-attention mechanisms to combine the text embeddings with the latent representation. After a fixed number of steps, the model decodes the latent representation into pixel space using a convolutional decoder. The model parameters, including weights and biases of each layer, are obtained by pre-training on large datasets of text-image pairs using an objective function such as a variational or denoising loss. During training, the model minimizes an error function between predicted noise and true noise using gradient-based optimization such as stochastic gradient descent or an adaptive optimizer. The server stores the trained model parameters and uses them only for inference at runtime.

The server uses these specific architectures and training procedures so that the generative AI model can respond sensitively to variations in the prompt sentence and produce high-fidelity, semantically aligned visual compositions. The prompt sentence generation process on the server is designed to feed features such as mood, color tone, and subject into the generative AI model in a consistent and normalized manner. This reduces variance in the model's output, leading to more predictable design results and fewer repeated generations.

The terminal receives the generated visual composition data, such as raster images in a defined resolution and format. The terminal decodes the data into an internal image representation and displays the images on the display device. The terminal may present multiple candidate images in a gallery view, each associated with identifier information received from the server or the generative AI model.

The user inspects the displayed images and provides evaluation information and modification request information. The user may, for example, select one image as a favorite, rate images, or enter additional instructions such as:

“I like this design, but please make the colors softer and add more white space.” “Please increase the contrast and make the flowers larger.”

The terminal converts this feedback into character information and sends it to the server. The server processes this new character information using the same natural language processing pipeline, but now associates the extracted features with previously stored structured information and the identifier of the selected image. For example, the server interprets “make the colors softer” as a request to modify the color_tone attribute and “add more white space” as a request to adjust a layout or density attribute. The server updates the structured information with new feature values and generates a refined prompt sentence such as:

“Please refine the previous bright floral design by using softer colors, adding more white space, increasing contrast, and making the flowers larger.”

The server may embed references to previous designs as prompt modifiers (e.g., “refine the previous design” along with an internal identifier) when using a generative model that supports conditioning on prior outputs. By representing feedback as structured changes to feature information, the server avoids re-parsing the entire design preference from scratch and instead makes incremental, feature-level modifications.

The server stores each generated visual composition data item, the associated prompt sentence, the structured feature information, and identification information in a storage device. The server organizes the storage using indexed tables where each record includes fields for visual composition location (e.g., file path or binary object), the final prompt sentence, feature values (mood, color_tone, subject, and possibly other attributes), and a reference to the user. This association allows the server to later retrieve visual compositions that correspond to similar feature patterns without re-invoking the generative AI model, thereby reducing computation and communication costs.

The server uses these data structures to implement technical optimizations. For example, the server may detect that a new set of feature information is sufficiently similar to a previously stored set (according to a similarity function over feature vectors) and can directly return an existing visual composition or adjust it slightly rather than requesting an entirely new image from the generative AI model. This reduces the number of large neural network inferences and thus decreases processing time and network usage. Also, because feature extraction normalizes user input into finite categories, the server can cache visual compositions by feature keys, such as combinations of mood, color_tone, and subject, and quickly select appropriate cached designs.

The server thereby improves computer technology in multiple ways. First, by converting unstructured natural language input into normalized structured feature information, the server reduces ambiguity at the interface between user input and machine processing. This leads to more efficient memory use and reduces redundant parsing on subsequent iterations, because updated prompts can be generated by simple updates to the structured information rather than re-processing the entire text from scratch. Second, by associating prompt sentences and feature information with generated visual compositions, the server enables indexing and caching mechanisms that directly reduce the computing load on the generative AI model and reduce communication overhead. Third, by employing prompt templates that explicitly encode emotional and visual attributes, the server improves the alignment between user intent and model behavior, thus lowering the number of iterations required for the user to reach a satisfactory design. This directly improves throughput and latency in a multi-user server environment.

The server uses AI and machine learning methods not merely as an automation of human drafting, but as a technical mechanism for re-structuring textual input into an internal representation optimized for computer processing. The natural language processing component transforms free-form language into feature vectors and categorical labels that can be processed much more efficiently by the generative AI model and the storage subsystem than raw text. The generative AI model itself uses a specific architecture (e.g., transformer encoder plus diffusion decoder) that operates with high-dimensional embeddings and iterative denoising, which is fundamentally not how a human designer would operate. The server orchestrates these non-human, algorithmic processes according to a specific, non-conventional sequence: extraction of normalized features, template-based prompt construction, inference with a large-scale neural network, structured storage, and feature-based iterative refinement. This non-conventional dataflow yields measurable technical advantages in terms of computational efficiency, precision of design generation, and management of generated data.

In another embodiment, the server uses a different class of generative AI model, such as a variational autoencoder or a generative adversarial network, to implement the visual composition generation. For instance, the server may use a generator network conditioned on a feature vector derived from the prompt sentence, and a discriminator network trained to distinguish realistic designs from synthetic ones. In that case, the server encodes the feature information into a numeric vector and passes it to the generator alongside random latent input. The generator produces candidate images, and during training, a discriminator network evaluates these images; the server updates model weights using an adversarial loss function and an optimizer. After training, the server uses only the generator for inference.

In a further embodiment, the server executes the generative AI model entirely locally, using one or more graphics processing units. The server deploys the text encoder and image decoder on GPU hardware and controls GPU memory allocation, batching of prompt sentences, and parallel processing of user requests. By normalizing and structuring feature information, the server can group similar requests into batches and process them together, improving GPU utilization and reducing per-request overhead. This leads to faster inference and lower energy consumption.

In yet another embodiment, the terminal performs a portion of the computation, such as preprocessing user input to detect language or to perform on-device sentiment analysis using a lightweight model. The terminal may embed preliminary feature information into the request sent to the server, enabling the server to skip some analysis steps and thereby further reduce latency. In this variant, the roles of server and terminal can be distributed according to available computational resources.

In all embodiments, the server, the terminal, and the user cooperate such that the system is not merely a generic data acquisition and display pipeline. Instead, the system implements a specific series of transformations of user input into structured feature information, then into prompt sentences, then into visual composition data through a defined generative AI architecture, and finally into persistent, feature-indexed storage. This structure achieves improved processing speed, reduced communication load, and higher precision in matching generated designs to user mood and preferences, thereby improving the operation of the computer system itself.

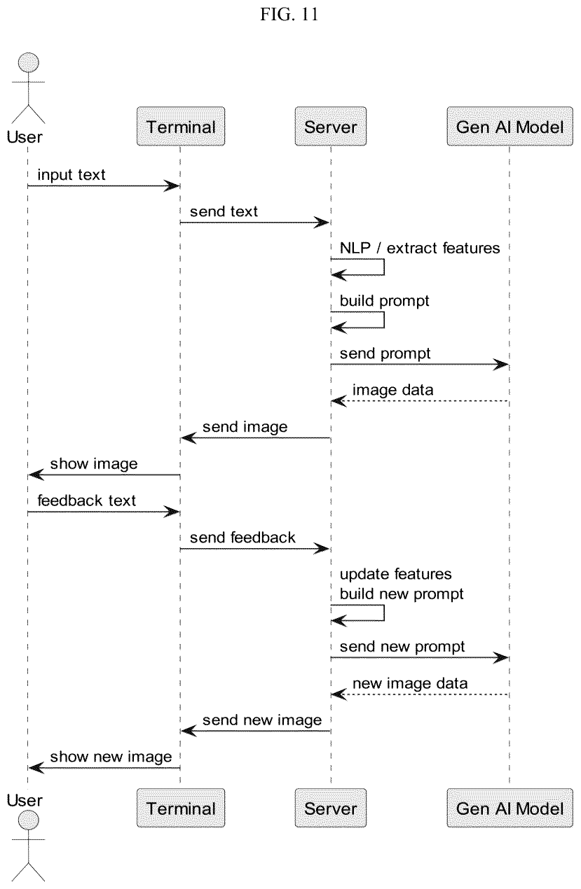

The following describes the processing flow using FIG. 11.

### Step 1

The user provides an initial design request.

The user operates the terminal and inputs natural language text describing mood and design preferences, for example “I feel energetic today, so I want a bright floral design.” The input is provided via a text input field or speech input. The terminal receives this input as character information (text string) and displays the entered text back to the user for confirmation.

Input: raw natural language text from the user.

Output: confirmed character information stored in the terminal.

### Step 2

The terminal transmits the character information to the server.

The terminal packages the character information with metadata such as a user identifier and language code into a request message. The terminal serializes this data into a structured format and sends it to the server over a communication network using a secure transport protocol.

Input: character information and metadata.

Output: network request containing character information delivered to the server.

### Step 3

The server receives and stores the character information.

The server accepts the network request, extracts the character information from the request body, and temporarily stores it in a memory buffer. The server may log the reception event with a timestamp in a storage device.

Input: network request containing character information.

Output: character information stored in server memory and available for processing.

### Step 4

The server performs basic text preprocessing.

The server normalizes the character information by converting character encoding, unifying case if appropriate, and removing or standardizing punctuation and extra whitespace. The server may also detect the language of the text using a lightweight classifier. These operations transform the raw text into a canonical form suitable for natural language processing.

Input: raw character information from server memory.

Output: normalized character information.

### Step 5

The server performs natural language processing to generate an internal representation.

The server loads a natural language processing model and applies tokenization, part-of-speech tagging, and dependency parsing to the normalized character information. The server transforms the text string into a structured representation such as a sequence of tokens with associated grammatical tags and a dependency tree.

Input: normalized character information.

Output: parsed text representation including tokens, tags, and dependency relations.

### Step 6

The server extracts feature information from the parsed text.

The server analyzes the parsed text using rule-based patterns and trained classifiers to identify mood expressions, color-related terms, subject-related terms, and other preference indicators. For example, the server recognizes “energetic” as a mood, “bright” as a color tone, and “floral design” as a subject. The server converts these findings into feature information by mapping detected phrases to canonical labels.

Input: parsed text representation.

Output: feature information such as mood, color tone, and subject.

### Step 7

The server generates structured information from the feature information.

The server constructs a data structure with predefined fields (for example, mood, color_tone, subject, usage) and assigns the extracted feature information to these fields. The server uses default or null values for fields not present in the input. This operation converts disparate feature values into a uniform structured information object.

Input: feature information.

Output: structured information object containing normalized attributes.

### Step 8

The server selects a template for an instruction sentence.

The server inspects the structured information to determine which fields are available and selects a sentence template that can express those attributes. For example, if mood, color_tone, and subject are available, the server selects a template such as “Please propose a {color_tone} {subject} design that matches a {mood} mood.” This selection is performed by a template selection module that compares available fields with template requirements.

Input: structured information object.

Output: selected template pattern.

### Step 9

The server generates an instruction sentence by template filling.

The server fills the selected template with the corresponding values from the structured information. The server performs character string processing such as placeholder replacement, insertion of articles (“a,” “an”), and adjustment of word forms. For the example, the server generates: “Please propose a bright floral design that matches an energetic mood.”

The server may further append technical constraints, generating extended sentences such as “Use vivid colors and a modern style. Output as a high-resolution illustration.”

Input: selected template pattern and structured information.

Output: instruction sentence in natural language.

### Step 10

The server converts the instruction sentence into a prompt sentence and request data.

The server designates the instruction sentence as the prompt sentence and packages it together with additional parameters such as desired resolution, number of outputs, and style hints into request data. The server formats this request data as a structure suitable for the generative AI model, including fields for the prompt sentence and numeric parameters.

Input: instruction sentence and system parameters.

Output: prompt sentence encapsulated in request data.

### Step 11

The server or the terminal sends the request data to the generative AI model.

In one configuration, the server acts as a client to an external generative AI service. The server transmits the request data including the prompt sentence to the generative AI model endpoint via a communication network. In another configuration, the terminal receives the prompt sentence from the server and sends the prompt sentence and parameters directly to a remote generative AI model. In both cases, the prompt sentence becomes the conditioning input to the generative AI model.

Input: request data containing the prompt sentence.

Output: network request delivered to the generative AI model.

### Step 12

The generative AI model generates visual composition data based on the prompt sentence.

The generative AI model encodes the prompt sentence using a text encoder that converts tokens into embedding vectors and processes them through multiple neural network layers.

The model then uses these embeddings to condition a generation process, such as a diffusion process or a generator network, which performs matrix multiplications and non-linear activations to produce an image tensor. The model decodes the tensor into pixel data and formats it as an image file or a similar representation.

Input: prompt sentence and generation parameters.

Output: visual composition data such as one or more images.

### Step 13

The server or the terminal receives the visual composition data from the generative AI model.

The receiving component parses the response, extracts the image data or identifiers, and stores the visual composition data in memory. If the server receives the data, the server may store the image data in a storage device and generate identification information; if the terminal receives the data directly, the terminal may temporarily cache the images for display.

Input: response containing visual composition data from the generative AI model.

Output: visual composition data stored locally and associated with identifiers.

### Step 14

The server stores associations between visual composition data, prompt sentence, and feature information.

When the server controls storage, the server writes a record to a storage device that links the visual composition data location with the corresponding prompt sentence and structured feature information. The server generates or uses existing identification information to index this record. This operation materializes the relationship between input features and generated outputs in a persistent data structure.

Input: visual composition data, prompt sentence, feature information.

Output: stored record associating identification information, visual composition data, prompt sentence, and feature information.

### Step 15

The terminal displays the visual composition data to the user.

The terminal retrieves visual composition data or an associated resource from the server or from its own cache, decodes the image representation into a displayable format, and renders it on the display. The terminal may arrange multiple images in a gallery layout and overlay selection controls.

Input: visual composition data and optional identification information.

Output: rendered images presented to the user on the terminal display.

### Step 16

The user evaluates the displayed visual composition data and optionally selects one or more items.

The user views the designs and interacts with the terminal by tapping, clicking, or using other interface actions to indicate preferences, such as selecting a preferred design or discarding unsatisfactory ones. The terminal records these actions as evaluation information (for example, selected design identifiers, ratings, or acceptance flags).

Input: displayed images and user actions.

Output: evaluation information representing the user's assessment.

### Step 17

The user provides modification request information as additional natural language input.

If the user wishes to refine a design, the user enters text describing desired changes, for example “Please make the colors softer and add more white space,” or “Increase the contrast and make the flowers larger.” The terminal captures this text as new character information, possibly together with references to specific designs being modified.

Input: user's refinement text and selected design identifiers.

Output: new character information and associated context.

### Step 18

The terminal sends evaluation information and modification request information to the server.

The terminal packages the evaluation information and the new character information into a structured message, including identifiers of the relevant visual compositions. The terminal transmits this message to the server over the communication network.

Input: evaluation information, modification request character information.

Output: network request containing feedback and modification data delivered to the server.

### Step 19

The server performs natural language processing on the modification request information and updates feature information.

The server processes the new character information using the same natural language processing pipeline used for the initial request. The server extracts new feature elements such as “softer colors,” “more white space,” “higher contrast,” and “larger flowers.” The server then updates the structured information linked to the selected design by modifying or adding these feature values. This produces a revised structured information object that reflects both original and updated preferences.

Input: modification request character information and existing structured information.

Output: updated feature information and revised structured information.

### Step 20

The server generates a refined prompt sentence based on the updated structured information.

The server selects an appropriate template for refinement instructions and fills it with the updated feature values. For example, the server generates a prompt such as “Please refine the previous bright floral design by using softer colors, adding more white space, increasing contrast, and making the flowers larger.” The server may include identifiers or textual references to the prior design if the generative AI model supports conditioning on previous outputs.

Input: revised structured information.

Output: refined prompt sentence for the generative AI model.

### Step 21

The server or the terminal sends the refined prompt sentence to the generative AI model to obtain updated visual compositions.

The server or the terminal embeds the refined prompt sentence in a new request data structure and sends it to the generative AI model as before. The generative AI model processes the refined prompt sentence and generates new visual composition data that incorporate the requested modifications.

Input: refined prompt sentence and generation parameters.

Output: updated visual composition data reflecting the user's refinement.

### Step 22

The server updates storage with new visual composition data and associated information.

The server stores the newly generated visual composition data in association with the refined prompt sentence, the updated feature information, and new identification information. The server may also maintain links between the original and refined designs to support navigation and reuse.

Input: updated visual composition data, refined prompt sentence, updated feature information.

Output: updated storage records associating original and refined designs.

### Step 23

The terminal presents the updated visual compositions to the user for further evaluation or final selection.

The terminal displays the new images and allows the user to compare them with previous designs if desired. The user can repeat the refinement process or select a final design. When the user confirms a final choice, the terminal sends a final selection signal to the server, which marks the corresponding record as a final visual composition for that user.

Input: updated visual composition data and user actions.

Output: final selection information and confirmation of the chosen visual composition.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems typically rely on predefined rules, static scoring functions, or simple keyword matching between user inputs and product attributes. Such systems are limited in their ability to interpret nuanced, natural language expressions of a user's mood and preferences, and therefore often produce generic or poorly targeted recommendations. As a result, the computational resources of a server are not effectively utilized to generate contextually rich recommendation outputs, and the overall performance of the human-computer interaction remains suboptimal.

In particular, when a user inputs free-form text describing a current mood or situational preference, existing systems generally either ignore mood-related expressions or process them in a shallow manner, causing the underlying hardware and software resources to operate as mere data retrieval engines rather than as context-aware processing systems. This leads to several technical problems: (i) increased processing overhead in the server due to ad hoc or repeated post-processing in the client, (ii) inefficient use of network bandwidth caused by transmission of unstructured, verbose results that require further interpretation on the terminal side, and (iii) lack of a standardized, machine-optimized interface between the server and a generative AI model, which forces the system designer to hard-code many different query formats and parsing routines.

Furthermore, traditional architectures do not provide a systematic mechanism for converting user input into a prompt sentence that is specifically optimized for a generative AI model, nor do they provide a structured data pipeline for transforming the natural-language output of the generative AI model into machine-readable product information. As a consequence, server-side processing becomes fragmented and difficult to scale, and it is difficult to improve the precision and efficiency of recommendation generation as a computer technology.

Accordingly, there is a need for an improved computer-implemented technique that, on a server side, (i) systematically analyzes user mood and preference information included in input data, (ii) generates a standardized prompt sentence tailored to a generative AI model, and (iii) converts the obtained natural-language recommendation result into structured data suitable for efficient transmission to and rendering by an information processing terminal. By addressing these issues, the operation of the server, the utilization of the generative AI model, and the communication between the server and the terminal can be technically improved in terms of processing efficiency, scalability, and consistency of recommendation quality.

The specific processing by the specific processing unit 290 of the data processing device 12 in Application Example 1 is realized by the following means.

The present invention provides a server comprising a processor configured to provide, via an information processing terminal, a user interface through which input information including mood information and preference information of a user is received, to analyze the mood information and the preference information included in the input information by executing natural language processing to extract expressions corresponding to product attribute information and category information, to generate a prompt sentence that includes an instruction for a generative AI model to generate product proposal information based on the product attribute information and the category information and that further specifies at least one of an output format and a number of product proposals, to input the generated prompt sentence into the generative AI model and acquire, from the generative AI model, the product proposal information in natural language generated in response to the prompt sentence, to convert the product proposal information into structured data by dividing the product proposal information into individual items and mapping each item to structured data including at least a product identifier and a product description, and to transmit the structured data to the information processing terminal for presentation to the user via the user interface. This enables the server to optimize the interaction between user input processing and the generative AI model through a standardized prompt sentence layer, to reduce client-side processing by delivering machine-readable structured data instead of unstructured natural-language text, and to improve overall computational efficiency and recommendation accuracy of the computer-implemented recommendation system.

The term “system” refers to a combination of one or more hardware devices and software components that cooperatively execute processing operations to implement the functions described in the claims.

The term “processor” refers to a hardware computation unit, such as a central processing unit, a graphics processing unit, or a specialized processing circuit, that executes instructions to perform data processing operations.

The term “information processing terminal” refers to an electronic apparatus operated by a user, such as a mobile communication device, a portable computing device, or a stationary computing device, that transmits input information to a server and presents output information to the user.

The term “user interface” refers to a software-controlled input/output environment, including graphical, textual, or audio elements, through which a user provides input information and receives output information via an information processing terminal.

The term “input information” refers to data provided by a user through the user interface, including at least natural language text that expresses the user's mood information and preference information.

The term “mood information” refers to information contained in the input information that indicates an emotional or psychological state of the user, such as being energetic, relaxed, or tired.

The term “preference information” refers to information contained in the input information that indicates the user's desired characteristics of items, such as styles, colors, patterns, categories, or usage situations.

The term “product attribute information” refers to information representing characteristics of items to be recommended, including at least one of a style attribute, a color attribute, a pattern attribute, a material attribute, or a usage attribute, which is derived from the mood information and the preference information.

The term “category information” refers to information indicating a classification of items to be recommended, such as a general product genre, a subcategory, or a usage category, which is derived from the mood information and the preference information.

The term “natural language processing” refers to a computational technique for analyzing and interpreting human language text, including at least one of tokenization, part-of-speech tagging, entity extraction, or keyword extraction.

The term “expression” refers to a word, phrase, or textual segment contained in the input information that represents or implies the mood information or the preference information.

The term “template” refers to a predefined textual or structural pattern including one or more placeholders that are filled with the extracted expressions, product attribute information, or category information to form a complete prompt sentence.

The term “prompt sentence” refers to an instruction text generated by the processor and provided as input to a generative AI model, the instruction text specifying at least requested content, output format, or quantity of product proposals to be generated.

The term “generative AI model” refers to a machine learning model configured to receive a prompt sentence and generate output information in natural language, the machine learning model being implemented, for example, as a neural network trained on text data.

The term “product proposal information” refers to information output by the generative AI model in natural language that describes recommended items, including at least an item name, an item type, or a brief explanation.

The term “structured data” refers to data organized in a predefined schema, such as a record or an object including fields for a product identifier, a product description, and optionally other attributes, the data being suitable for machine processing and transmission.

The term “product identifier” refers to data that uniquely or distinctively identifies a product within a system, such as a code, a key, or an index used for retrieval or display.

The term “product description” refers to textual data that provides information about a product, including at least one of a name, a feature explanation, a usage suggestion, or a style indication.

The term “output format” refers to a specification of the structure, layout, or organization of text or structured data to be generated by the generative AI model, such as a list format, a numbered format, or a field-based format.

The term “number of product proposals” refers to a quantity specification included in the prompt sentence that defines how many product proposal items the generative AI model is requested to generate.

The term “transmit” refers to the operation of sending data from the server to the information processing terminal over a communication network using one or more communication protocols.

The term “acquire” refers to the operation by which the processor receives or obtains data from another component, device, or model, such as receiving product proposal information from the generative AI model.

The term “mapping” refers to the operation of associating or converting one type of data, such as natural-language product proposal information, into another type of data, such as structured data including a product identifier and a product description.

The term “presentation” refers to the operation of causing the information processing terminal to display or otherwise output product information to the user via the user interface.

In one embodiment, a server cooperates with one or more terminals operated by users to implement a recommendation system that generates product proposals based on a user's mood and preferences using a generative AI model. The server includes at least one hardware processor, a memory device storing program instructions and data, and a network interface configured to communicate with the terminals and with a remote computational resource executing the generative AI model. The terminal includes a display unit, an input unit, a local processor, a local memory, and a communication interface.

A user uses a terminal, such as a smartphone, a tablet, or a personal computer, to execute an application program that provides a graphical user interface. The terminal presents an input field and optional guidance text, through which the user inputs natural language text describing a current mood and desired product characteristics. The terminal converts the user input into a structured internal representation, for example, an object containing fields for raw text and metadata, and the terminal transmits this representation to the server over a network using a predefined application protocol.

The server receives the user input via the network interface and stores the input in the memory device. The server uses the processor to execute software modules, which in one implementation are realized as a backend framework running on a general-purpose operating system. The server executes a natural language processing module that processes the input text data. The natural language processing module performs tokenization, part-of-speech tagging, syntactic parsing, and named entity recognition using an NLP library. In one embodiment, the server uses a pipeline including wordpiece or subword tokenization, a statistical or neural tagger for part-of-speech information, and a pattern-matching engine for extracting mood-related and preference-related expressions.

The server extracts mood information such as “relaxed,” “energetic,” or “tired,” and preference information such as “bright floral designs,” “calm-colored interior items,” or “simple cool-colored loungewear.” The server maps these expressions to higher-level product attribute information and category information by consulting one or more mapping tables stored in the memory. For example, the server maps “bright floral designs” to color attributes {“bright”}, pattern attributes {“floral”}, and a product category {“fashion items”}. The server stores intermediate results in data structures including arrays of tokens, dictionaries of feature-value pairs, and vectors representing semantic categories.

The server then generates a prompt sentence for a generative AI model. The server uses a template-based prompt generator module that is executed by the processor. This module combines the extracted mood information and preference information with a predefined linguistic structure. The module selects a template according to the recognized category, for example, a “fashion template” or an “interior template,” and fills placeholder positions with the extracted attribute and category information. The result is an instruction text tailored to the generative AI model. For example, the server generates a prompt sentence such as: “The user's mood is energetic. Please recommend bright-colored floral design products, including clothing and accessories, that match an energetic mood. Output a list of product suggestions with short descriptions.”

In another example, the server generates a prompt sentence such as:

“The user's mood is relaxed. Please recommend calm-colored interior products for the living room, such as cushions, rugs, and lighting items, that match a relaxed mood. Provide several product suggestions with short explanations.”

In yet another example, the server generates a prompt sentence such as:

“The user's mood is calm and slightly tired. Please recommend simple loungewear products in cool colors, such as blue, gray, or green, that help the user relax. Provide several product ideas with short descriptions.”

The server constructs the prompt sentence as a specific sequence of character data stored in the memory and passes this sequence as an input to a generative AI model. In one embodiment, the generative AI model executes on a remote computing environment that includes one or more graphics processing units or tensor processing units configured to perform large-scale matrix multiplications. The generative AI model is implemented as a deep neural network, for example a transformer-based architecture having multiple encoder and decoder layers. Each layer includes self-attention modules, feedforward networks, and normalization operations. The model stores trainable parameters such as weight matrices for attention, projection matrices, and bias vectors, each represented as multidimensional arrays in the model memory. During inference, the model processes the prompt sentence tokens using attention mechanisms to compute contextual embeddings and generates output tokens stepwise, applying a decoding algorithm such as greedy decoding, beam search, or nucleus sampling.

The generative AI model is trained in advance using a training dataset composed of large-scale text corpora including dialogue data, descriptive texts of items, and structured product attribute information. The training procedure uses stochastic gradient descent or a variant such as Adam optimization. A loss function, such as cross-entropy loss between predicted token distributions and ground truth tokens, is minimized. During training, the model adjusts its parameters by backpropagation. The training process may include data augmentation methods, such as synonym replacement, paraphrasing, or masked language modeling tasks, to improve robustness. The model learns latent representations of mood expressions, style descriptors, and product-related terminology, which allows the model to infer product suggestions that are semantically aligned with the prompt sentence.

The server communicates with the generative AI model via an application programming interface. The server formats the prompt sentence, attaches metadata such as desired output length and temperature settings, and transmits an inference request over an encrypted channel. The generative AI model returns generated text representing product proposal information. The generated text includes one or more lines corresponding to recommended products, usually in a list format with descriptions.

The server receives the generated text and executes a post-processing module. The post-processing module runs on the processor and uses regular expressions, pattern recognition rules, and optionally an auxiliary classifier model to divide the text into individual product items. The server converts each item into structured data objects by extracting a title, a summary description, and optional attribute tags. The server may access a product database implemented in a relational database management system and execute queries based on the extracted attributes. The server matches the generated descriptions to actual stored product records using similarity metrics such as cosine similarity between embedding vectors or approximate string matching. The server thereby assigns product identifiers, image resource identifiers, and uniform resource locators to each recommendation item.

The server stores the structured recommendation data in memory in a format such as a list of records, each record including fields for a product identifier, a product description, and links to visual resources. The server then transmits this structured data to the terminal. Because the data is already structured, the terminal does not need to perform complex natural language interpretation; instead, the terminal simply renders the data using graphical components.

The terminal receives the structured product information and uses its local processor to generate a user interface view. The terminal maps each record to a visual element, such as a card or list item, and loads associated images from the provided resource links. The terminal displays product titles, short descriptions, and optionally price and availability data. The user views the displayed recommendations and may select one or more products. When the user requests more details or a different set of recommendations, the terminal transmits corresponding requests to the server, which repeats the described processing.

In this configuration, the server improves computer technology in several ways. First, the server introduces an explicit prompt sentence layer between the user input and the generative AI model. The server transforms raw user text into a standardized, machine-optimized instruction. This transformation reduces variability in model inputs and results in more stable and predictable outputs from the generative AI model. As a consequence, the server reduces the need for ad hoc error handling and reformatting on the terminal, thereby lowering processor load on client devices and reducing network bandwidth consumption because less redundant information is transmitted.

Second, the server uses a specific data structure pipeline: unstructured user text is transformed into token sequences, feature dictionaries for mood and preferences, higher-level product attribute vectors, and finally structured product records. This pipeline allows the server to cache intermediate representations and reuse them for subsequent user interactions, which reduces total computation time. The separation of extraction, prompt generation, and post-processing modules allows parallel execution on multi-core processors and efficient scaling across multiple server instances.

Third, the server cooperates with the generative AI model in a non-conventional manner by constraining and guiding the model through carefully constructed prompt sentences that include explicit instructions about output format and number of product proposals. This reduces variance in output length and structure, which simplifies parsing and mapping into structured data. The reduction in post-processing complexity leads to faster response times and lower error rates in automatic item extraction, thereby improving the technical performance of the recommendation pipeline.

Fourth, the server uses a combination of rule-based parsing and embedding-based similarity matching to link generated product descriptions to actual product records. This hybrid approach, which leverages both symbolic rules and learned vector representations, improves matching accuracy compared to simple keyword-based systems. The improved accuracy reduces the frequency of mismatches and eliminates certain error-handling routines, thereby reducing required CPU cycles and I/O operations for correction steps.

Fifth, the training method and architecture of the generative AI model are designed so that the model encodes generalized relationships between mood expressions, style descriptors, and product features. During inference, the model can produce recommendations even when user inputs include rare or previously unseen combinations of mood and preference expressions.

This capability reduces the need for large rule sets or manual curation of mapping tables on the server side. As a result, the server maintains smaller rule databases, which improves memory utilization and reduces maintenance overhead for rule updates.

The system is not limited to a single type of terminal or a single category of products. In another embodiment, the server uses the same processing approach to generate configuration proposals for physical devices, such as lighting systems or interior layouts, wherein the structured product information includes parameters for device controllers. In such a case, the server translates generated recommendations into device control parameters and transmits these parameters to a home automation hub. The hub then drives lighting hardware or other actuators according to the recommended configurations. This illustrates that the generative AI model output is not merely displayed as information but is used to control external equipment in a predictable, machine-interpretable manner, thereby further emphasizing the technical nature of the processing.

In another embodiment, the server supports multiple generative AI models. The server selects a particular model instance or model version based on the category information inferred from the user input. For example, one model is specialized for fashion products and another model is specialized for interior products. The server maintains a routing module that maps category information to model identifiers. This routing reduces unnecessary computational load on generalized models and improves the quality of recommendations in each domain, which in turn improves overall computation efficiency and reduces latency.

In a further embodiment, the server maintains a feedback module that monitors user interactions with the recommended items, such as selections, purchases, or explicit feedback.

The server aggregates this behavior data as additional feature vectors and uses it to adjust prompt sentence templates or weighting factors in the mapping between expressions and product attributes. The server may also periodically retrain auxiliary classifier models used in the pipeline using this feedback data. This closed-loop adaptation mechanism improves recommendation accuracy over time and reduces the need for manual tuning by system administrators.

By employing the described architecture, the server and the terminal realize a technical solution that goes beyond mere automation of human selection tasks. The server performs structured transformation of natural language input into optimized prompt sentences and structured outputs, controls the flow of data between hardware modules, and improves computation efficiency, accuracy, and resource utilization across the entire system. The concrete configuration of data structures, neural network architectures, training procedures, and processing modules provides a technical implementation that can be practiced by those skilled in the art based on the present description.

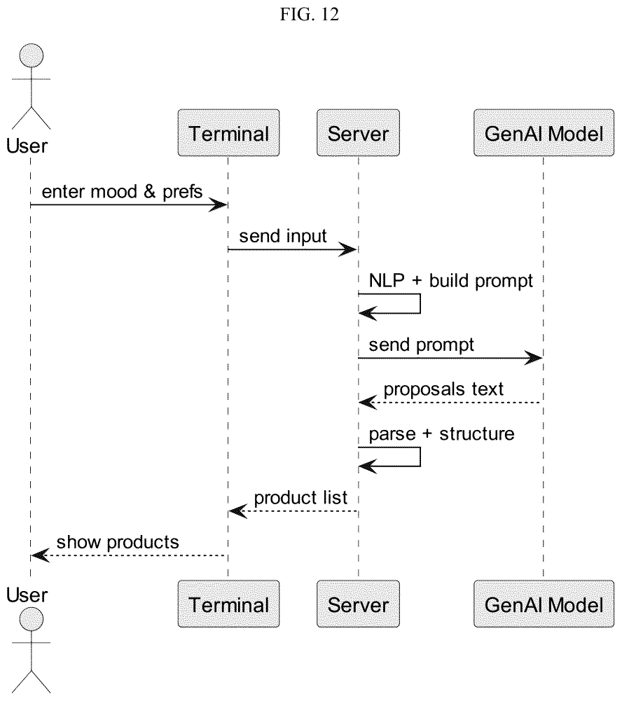

The following describes the processing flow using FIG. 12.

### Step 1

The user operates the terminal to launch an application that provides a graphical user interface. The terminal displays one or more input fields and guidance text requesting the user to describe a current mood and desired product characteristics in natural language. The user inputs text, for example, “Today I feel relaxed. I want calm-colored interior items for my living room,” using an on-screen keyboard or other input device. The terminal receives this text as input and stores it in a local data structure, such as a string variable within an object that also includes a timestamp and a session identifier. The terminal then converts this object into a structured message and prepares it as the output of Step 1.

Input: User's natural language text describing mood and preferences.

Output: Structured input data object on the terminal containing the user text and associated metadata.

### Step 2

The terminal transmits the structured input data object to the server via a communication network. The terminal encapsulates the data object into a network message using a predetermined communication protocol and sends the message to a specified server address.

The terminal sets appropriate headers and encodes the payload as a sequence of bytes. The terminal thereby converts the internal representation of the user input into a network-level representation and outputs this network message for delivery to the server.

Input: Structured input data object on the terminal.

Output: Network message containing the user input data transmitted to the server.

### Step 3

The server receives the network message through a network interface and decodes the payload to reconstruct the structured input data object. The server uses a protocol handler to parse headers and extract the body of the message. The server stores the reconstructed object in memory and extracts fields containing the raw user text, the timestamp, and any session information. The server thereby transforms the network-level data into an internal server-side representation and outputs a server-side input object for further processing.

Input: Network message containing user input data.

Output: Server-side input object including raw user text and metadata.

### Step 4

The server executes a text preprocessing operation on the raw user text. The server removes leading and trailing whitespace, normalizes character encoding, converts full-width characters to half-width where applicable, and standardizes punctuation. The server may also apply language detection to determine whether the text is in a particular language and then select appropriate tokenization rules. The server thus converts unnormalized raw text into cleaned text suitable for natural language processing and stores the result as a cleaned text string.

Input: Server-side input object including raw user text.

Output: Cleaned text string prepared for natural language processing.

### Step 5

The server performs natural language processing on the cleaned text string to extract mood information and preference information. The server executes tokenization to divide the text into tokens, applies part-of-speech tagging to identify grammatical roles, and uses pattern-based or model-based recognition to detect phrases that express mood (for example, “relaxed,” “energetic,” “tired”) and preferences (for example, “calm-colored interior items,” “bright floral clothes”). The server maps detected phrases to internal categories such as mood labels and product attributes using mapping tables or classification models. By these operations, the server converts a sequence of tokens into structured feature data consisting of mood labels, attribute labels, and preliminary category labels.

Input: Cleaned text string.

Output: Structured feature data including mood labels, product attribute labels, and category labels.

### Step 6

The server generates product attribute information and category information based on the structured feature data. The server consults one or more mapping tables stored in memory to associate detected phrases with higher-level attributes such as color category, pattern category, and item category. For example, the server maps “calm-colored” to a color attribute set {“beige,” “light gray,” “pale blue”}, and maps “interior items for my living room” to a category label {“interior products,” “living room use”}. The server aggregates these mappings into product attribute information and category information represented as structured records or vectors. The server thereby transforms intermediate feature-level data into higher-level semantic attributes that describe the desired products.

Input: Structured feature data including mood labels and preliminary category labels.

Output: Product attribute information and category information representing desired product characteristics.

### Step 7

The server constructs a prompt sentence for a generative AI model based on the mood information, product attribute information, and category information. The server selects a prompt template according to the category information, for example a template for fashion products or for interior products. The server then inserts the mood label, product attributes, and category descriptions into placeholder positions in the template. The server may also insert constraints on output format and number of recommendations. For example, the server generates a prompt sentence such as, “The user's mood is relaxed. Please recommend calm-colored interior products for the living room, such as cushions, rugs, and lighting items, that match a relaxed mood. Provide several product suggestions with short explanations.” This operation converts internal structured attribute data into a natural-language instruction optimized for the generative AI model.

Input: Mood labels, product attribute information, and category information.

Output: Prompt sentence in natural language configured for the generative AI model.

### Step 8

The server transmits the prompt sentence to the generative AI model and requests generation of product proposal information. The server encapsulates the prompt sentence into a model request structure, optionally including parameters such as maximum output length, decoding temperature, and requested format (for example, list-style output). The server sends this request via an interface to a remote computing resource that executes the generative AI model. The server converts the prompt sentence from an internal string representation into a model input representation and outputs a model inference request.

Input: Prompt sentence in natural language.

Output: Model inference request transmitted to the generative AI model.

### Step 9

The generative AI model processes the prompt sentence and generates product proposal information. The model receives the prompt sentence tokens, computes internal contextual embeddings using multiple transformer layers, and applies self-attention and feedforward operations to propagate information across tokens. The model uses learned weight parameters to evaluate likely next tokens and assembles an output sequence of tokens representing product proposals. The model decodes these tokens into text that typically lists multiple product ideas and associated descriptions. The generative AI model thereby converts the prompt sentence input into a natural-language output describing recommended items, and returns this output text to the server as response data.

Input: Tokenized prompt sentence representing an instruction.

Output: Natural-language text containing product proposal information returned to the server.

### Step 10

The server receives the natural-language product proposal information from the generative AI model and stores it as a text string. The server then executes a post-processing module that parses this text. The server uses delimiter detection such as line breaks, numbering markers, or bullet symbols to separate the text into individual product entries. The server applies additional parsing rules or auxiliary classifiers to identify a title segment and a description segment for each entry. The server thereby transforms a single text string into a list of product proposal entries, each represented as a text-based item structure.

Input: Natural-language text containing product proposal information.

Output: List of text-based product proposal entries, each including at least a title and a description.

### Step 11

The server converts each text-based product proposal entry into structured data and optionally links each entry to stored product records. The server creates a structured record for each entry, assigning fields such as “product_title” and “product_description” from the parsed text.

The server may compute embedding vectors for the title and description and query a product database to find the closest matching stored products using similarity measures. When a match is found, the server stores product identifiers, image references, and URLs in the structured record. The server thereby transforms unstructured natural-language entries into structured product data suitable for efficient storage, retrieval, and transmission.

Input: List of text-based product proposal entries.

Output: Structured product data records including at least product titles, product descriptions, and optionally product identifiers and resource links.

### Step 12

The server assembles the structured product data records into a response data object and transmits this object to the terminal. The server serializes the list of records into a transport format and sends the resulting data over the network interface to the terminal. The server ensures that the response contains only necessary structured fields and omits redundant natural-language information to reduce data size. The server thereby converts internal structured records into a network-ready response and outputs a response data object addressed to the requesting terminal.

Input: Structured product data records generated by the server.

Output: Network response containing structured product data transmitted to the terminal.

### Step 13

The terminal receives the network response from the server and decodes the payload to reconstruct the structured product data records. The terminal stores the reconstructed records in local memory and prepares them for rendering. The terminal then creates user interface components, such as list items or cards, for each product record. The terminal assigns titles, descriptions, and image resources to the visual components and arranges them in a layout suitable for browsing. The terminal thereby transforms structured data from the server into visual display elements that present the product information to the user.

Input: Network response containing structured product data.

Output: Rendered user interface elements displaying product recommendations on the terminal.

### Step 14

The user views the displayed product recommendations on the terminal and may select a product or request additional recommendations. When the user selects an item, the terminal detects the selection event and generates a follow-up request that includes a product identifier or a refinement query. The terminal transmits this follow-up request to the server, which can then repeat Steps 3 through 13 to generate updated or more detailed proposals. The user's actions thus form new inputs that trigger further cycles of data processing, recommendation generation, and display.

Input: Displayed user interface with recommended products; user's selection or refinement input.

Output: Follow-up request data sent from the terminal to the server to initiate additional processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2.

The units of the system described below are implemented by the data processing device 12 and the smart device 14. The data processing device 12 is called a “server” and the smart device 14 is called a “terminal”.

Conventional computer-implemented design generation systems that utilize a generative AI model typically accept a short, ambiguous natural language description from a user and directly submit that description to the model as a prompt. In such systems, a processor usually performs only simple input relay and does not perform structured natural language processing to extract syntactic, semantic, and sensitivity-related information, nor does it construct an optimized design prompt sentence tailored to the specific behavior of the generative AI model. As a result, the generative AI model is frequently provided with incomplete or underspecified prompts, causing the model to generate design images whose visual expression, color scheme, and composition deviate from the user's actual intent. This leads to low first-pass accuracy, repeated trial-and-error by the user, and increased computational load on the server side.

Furthermore, in many existing systems, the user interface for interacting with the generative AI model is not integrated with a machine-side prompt optimization process. The system usually does not support an iterative workflow in which the processor collects user corrections on intermediate prompt sentences and dynamically refines a final prompt sentence used as input to the generative AI model. Consequently, the system cannot effectively exploit user feedback to guide subsequent generation rounds, which results in inefficient utilization of computing resources and prolonged interaction time. Moreover, the processor in such systems does not systematically incorporate atmosphere information, preference information, and usage-purpose information extracted from user text into a structured prompt, and therefore cannot provide stable, reproducible control over the expression direction of the design image.

From the viewpoint of computer technology, these limitations manifest as low efficiency and poor controllability of AI inference processing on a server. The server-side processor is not architected to perform multi-stage text analysis, prompt construction, and interactive refinement before invoking the generative AI model. Accordingly, there is a need for an improved system architecture in which the processor itself implements an optimized processing pipeline: receiving user text through a terminal device, extracting feature information by natural language processing, generating and presenting an intermediate design prompt sentence for user review, acquiring user corrections in a structured manner, and then determining and supplying a final prompt sentence to the generative AI model. Such an architecture should improve the alignment between user intent and generated designs, reduce unnecessary inference operations, and thereby enhance the overall performance and technical effect of the computer system that executes the generative AI model.

The specific processing by the specific processing unit 290 of the data processing device 12 in Example 2 is realized by the following means.

The present invention provides a server comprising a processor configured to provide, to a terminal device, a user interface screen for receiving, as character information, a user request related to a design, to execute natural language processing on the character information to extract feature information including syntactic information, semantic information, and sensitivity-related information, to generate, on the basis of the extracted feature information and the character information, a design prompt sentence to be input to a generative AI model, to transmit the design prompt sentence to the terminal device for user confirmation and correction, to acquire a correction result from the terminal device, to determine, on the basis of the correction result, a final prompt sentence as an input sentence to the generative AI model, to input the final prompt sentence to the generative AI model so as to cause the generative AI model to generate a design image corresponding to the final prompt sentence, and to cause at least one of the terminal device and a storage apparatus to present and store the generated design image. This enables the computer system to implement an integrated, processor-controlled prompt optimization and interactive refinement pipeline that improves alignment between user intent and model input, thereby enhancing the efficiency, controllability, and quality of AI-based design image generation while reducing redundant inference processing.

The term “processor” refers to a hardware or virtual computing element, such as a central processing unit, a graphics processing unit, or a processing core in a distributed computing environment, that executes instructions to perform the functions described herein.

The term “terminal device” refers to an information processing apparatus having at least an input unit, a display unit, and a communication unit, such as a smartphone, a tablet, a personal computer, or another user-operated device, which communicates with the server and presents a user interface screen.

The term “user interface screen” refers to a display region provided on the terminal device that includes one or more graphical or textual components through which a user can input information, view system outputs, and perform operations related to the design generation process.

The term “character information” refers to data representing a sequence of characters or symbols, including letters, numerals, and punctuation marks, which is input by a user or generated by the system in a text-based format.

The term “user request” refers to information representing a user's intention or requirement regarding a design, expressed in natural language or other textual form, and used as a basis for generating a design prompt sentence.

The term “request information” refers to structured data including at least character information representing a user request and communication control information such as identifiers, timestamps, or protocol parameters, which is transmitted between the terminal device and the server.

The term “communication control information” refers to data used to manage and control communication between devices, including but not limited to a user identifier, a request identifier, a session token, a timestamp, and protocol-related parameters.

The term “natural language processing” refers to a sequence of computational operations performed on character information, including tokenization, syntactic analysis, semantic analysis, language identification, and related processing for extracting feature information from textual data.

The term “feature information” refers to information derived from character information by natural language processing, including at least syntactic information, semantic information, and sensitivity-related information, which is used in constructing or updating a prompt sentence.

The term “syntactic information” refers to information regarding the grammatical structure of character information, such as parts of speech, phrase boundaries, and dependency relations, obtained through syntactic analysis.

The term “semantic information” refers to information regarding the meaning, concepts, or topics expressed in character information, including relationships between entities and attributes, obtained through semantic analysis.

The term “sensitivity-related information” refers to information related to subjective or affective aspects contained in character information, including, for example, atmosphere information, preference information, and usage-purpose information associated with a desired design.

The term “atmosphere information” refers to information indicating a perceived mood or ambiance desired by the user for a design, such as calm, bright, luxurious, or casual, extracted from character information.

The term “preference information” refers to information indicating a user's likes, dislikes, or favored styles, such as preferred colors, motifs, or design genres, derived from character information or user interaction history.

The term “usage-purpose information” refers to information indicating an intended use or application context of a design, such as use in an interior space, a product surface, a digital content asset, or a printed material.

The term “design prompt sentence” refers to a text sequence generated by the processor on the basis of feature information and character information, which provides detailed instructions regarding visual expression, color scheme, composition, and style to be used as input to a generative AI model.

The term “final prompt sentence” refers to a prompt sentence determined by the processor after reflecting user confirmation and correction of a design prompt sentence, which is supplied as an input sentence to the generative AI model to generate a design image.

The term “prompt sentence” refers generally to a text sequence formatted to be used as input to a generative AI model, including a design prompt sentence and a final prompt sentence.

The term “generative AI model” refers to a computational model, such as a neural network model trained on data including design-related content, that generates new data, including prompt text or design images, on the basis of given input information.

The term “design image” refers to visual data, such as a bitmap image or vector image, that represents a design output generated by the generative AI model in accordance with a prompt sentence

The term “visual expression element” refers to an attribute or descriptor related to the appearance of a design, including but not limited to shape, texture, pattern, or style, which is added to or specified in a prompt sentence.

The term “color scheme element” refers to an attribute or descriptor related to colors used in a design, including color tones, color combinations, and contrast relationships, which is added to or specified in a prompt sentence.

The term “composition element” refers to an attribute or descriptor related to the arrangement or spatial layout of components in a design, such as placement, balance, symmetry, and relative scale, which is added to or specified in a prompt sentence.

The term “expression direction” refers to a set of constraints or guidelines defining how a design image should express a desired concept, mood, or style, including visual expression elements, color scheme elements, and composition elements.

The term “correction result” refers to information representing changes, edits, or confirmations applied by a user to a design prompt sentence displayed on the user interface screen, which is transmitted from the terminal device to the processor.

The term “storage apparatus” refers to a physical or logical data storage component, such as a magnetic storage device, a solid-state storage device, or a network storage device, capable of storing design images, prompt sentences, and related metadata.

The term “present” refers to causing visual or other perceivable output related to a design image or prompt sentence to be displayed or otherwise output on the terminal device or another output device.

The term “iteratively updating generation processing” refers to repeatedly executing design image generation by the generative AI model while modifying a prompt sentence or input parameters on the basis of user edits or correction results obtained through the terminal device.

In the following embodiments, a server, a terminal, and a user cooperate to implement a system that generates a prompt sentence for a generative AI model and uses the prompt sentence to obtain a design image. The same reference is intended to cover hardware-based implementations, software-based implementations executed by general-purpose hardware, and combinations thereof.

### A. Overall Configuration of Hardware and Software

The server includes at least one processor, a main memory, a non-volatile storage device, a communication interface, and optionally a dedicated accelerator such as a graphics processing unit. The processor may be a general-purpose central processing unit. The main memory may be a volatile storage device such as a random access memory. The non-volatile storage device may be a magnetic storage device, a solid-state storage device, or a network storage device. The communication interface connects the server to a communication network such as the Internet via standard protocols.

The server executes an operating system and one or more application programs implementing a natural language processing module, a prompt generation module, a model serving client, a database access module, and a user interface management module. The natural language processing module may be implemented using a general-purpose library such as a tokenization and parsing library, a word embedding library, and a language identification library. The model serving client communicates with a generative AI model hosted on the same server or on a remote inference server.

The terminal includes a processor, a memory, a display device, an input device such as a touch panel or keyboard, and a communication module such as a wireless communication module. The terminal may be realized as a smartphone, a tablet, a personal computer, or a similar information processing device. The terminal executes an operating system and a client application program that presents a user interface screen for design requests, communicates with the server via a network protocol such as HTTPS, and displays prompt sentences and design images.

The generative AI model may be deployed on a computing node equipped with a processor and a hardware accelerator such as a graphics processing unit. The model serving environment may use a model inference server. The generative AI model is trained in advance and then receives prompt sentences and generates corresponding design images.

### B. Configuration of Generative AI Model and Training

The server uses a generative AI model that includes a neural network having a transformer-based architecture. The generative AI model includes an embedding layer that converts input tokens into continuous-valued vectors, a plurality of self-attention layers that compute attention weights between tokens, and a plurality of feed-forward layers that apply non-linear transformations to intermediate representations. The generative AI model may be realized as a text-to-image model that accepts a prompt sentence as text and generates an image in a latent space which is then decoded to a bitmap image.

The server trains the generative AI model before deployment or obtains a pre-trained model and optionally fine-tunes it. During training or fine-tuning, the server obtains a training dataset including pairs of text descriptions and design images. The server uses a loss function such as a cross-entropy loss on token predictions, a reconstruction loss in a latent space, or an adversarial loss when using a generative adversarial network component. The server updates network parameters by performing gradient-based optimization such as stochastic gradient descent or an adaptive optimizer. The server may apply data augmentation to the training images and text data, such as flipping, cropping, or random masking, to improve generalization.

The server, during inference, does not merely execute the generative AI model in a black-box manner. Instead, the server controls the input structure, sampling parameters, and intermediate prompt sentence so that the model is operated in a technically improved manner.

For example, the server adjusts parameters such as temperature, top-p, and maximum token length to balance diversity and determinism, thereby improving reproducibility and inference efficiency.

### C. Data Structures Used by the Server

The server stores request information in a structured format. Request information includes fields such as a user identifier, a request identifier, a timestamp, character information representing a user request, and language information. The server represents this information in a record of a database table. The server also stores feature information derived from natural language processing. Feature information includes syntactic information such as part-of-speech tags and dependency relations, semantic information such as detected topics and entities, and sensitivity-related information such as atmosphere information, preference information, and usage-purpose information.

The server stores a prompt sentence as a separate text field associated with a record. The server distinguishes between an intermediate design prompt sentence and a final prompt sentence by using a status field or a type field. The server stores design images generated by the generative AI model in an image storage table or object storage, and associates these images with the corresponding final prompt sentence and request identifier by means of metadata.

By using these explicit data structures, the server can index and retrieve historical requests and generated results efficiently. For example, the server can execute an indexed query on feature information to find similar past requests, which allows reuse or adaptation of previous prompt sentences and reduces computational load.

### D. Natural Language Processing and Feature Extraction

The server processes character information received from the terminal using the natural language processing module. The server tokenizes the character information into tokens, assigns part-of-speech tags, and computes dependency trees. The server identifies semantic entities such as color names, spatial descriptors, object categories, and style descriptors by using pattern matching or a trained classification model. The server also analyzes sensitivity-related information by mapping expressions in the character information to an internal affective space. For example, the server maps terms such as “calm,” “relaxing,” and “soft” to a low-arousal affective vector, and maps terms such as “bright,” “vivid,” and “energetic” to a high-arousal vector.

The server converts extracted features into a structured feature vector comprising numerical and categorical values. For example, the server encodes atmosphere information as a low-dimensional vector, preference information as binary flags indicating presence or absence of certain preferred attributes, and usage-purpose information as a one-hot vector representing categories such as interior space, apparel, or digital media. The server then uses this feature vector when constructing the prompt sentence.

By implementing natural language processing in this structured manner, the server improves the precision of prompt sentence generation. The server does not merely forward the user's raw text to the generative AI model but converts the text into a representation that isolates relevant attributes and suppresses noise. This leads to higher accuracy in the generated design images and reduces the number of repeated model invocations.

### E. Construction of Prompt Sentence

The server generates a design prompt sentence by combining the original character information and the structured feature information. The server uses a rule set and a template set in the prompt generation module. The rule set specifies how to translate feature information into textual clauses. For example, when atmosphere information indicates a calm mood and usage-purpose information indicates an office environment, the rule set instructs the server to insert phrases such as “serene office interior” and “minimalist layout that promotes focus.”

The server constructs the design prompt sentence according to a template, such as: “a [mood] [object category] with [materials], [color scheme], [spatial arrangement], and [lighting condition], in a [style] design style”

The server fills the template slots using attribute values derived from the feature vector.

When some slots are missing from the user's original input, the server fills them using default values determined by predefined rules or statistical priors. This non-conventional combination of rule-based template filling and machine-learned feature extraction is carried out automatically by the server and is not reducible to simple human-like paraphrasing.

Concrete examples of prompt sentences generated by the server include:
“a vivid, modern floral pattern with large, overlapping blossoms in bright pink, yellow, and turquoise, set against a clean white background, with flat, graphic shapes and high contrast suitable for fabric prints”
“a serene office interior with natural wood desks, soft gray walls, potted green plants, and warm indirect lighting, arranged in a minimalist layout that promotes focus and concentration, in a Scandinavian design style”

The server, by mapping feature information to a structured template, increases the density of relevant visual instructions in the prompt sentence. This yields a technical effect of improving the deterministic mapping from prompt sentence to design image, which reduces the variability in the generative AI model's outputs and enhances computational stability.

### F. Interactive Refinement and User Interface Control

The terminal presents the design prompt sentence in an editable text field on the user interface screen. The terminal displays both the original user request and the generated prompt sentence, allowing the user to compare them. The terminal permits the user to modify parts of the prompt sentence, such as replacing “bright pink” with “deep red,” adding “gold accents,” or specifying “smaller flowers.”

The terminal transmits the edited prompt sentence back to the server together with a reference to the previous request. The server receives the edited text, reprocesses it through the natural language processing module, and constructs a final prompt sentence that reflects both the system's internal feature mapping and the user's explicit corrections. Because the server manages the prompt sentences and associated feature vectors explicitly, the server can selectively update only those parts of the feature vector that correspond to edited portions, thereby reducing redundant computations.

By enabling the user to refine the prompt sentence while the server maintains a structured representation, the system achieves a form of co-operative control over the generative AI model that goes beyond simple manual editing. The server uses user edits as signals to update internal feature vectors, which are then re-injected into the prompt generation process, leading to convergent prompt sentences and more accurate design images.

### G. Invocation of Generative AI Model and Technical Effects

The server supplies the final prompt sentence to the generative AI model. The server first tokenizes the final prompt sentence using a tokenizer consistent with the generative AI model. The server then converts tokens into embeddings and feeds them into the model. The generative AI model processes the embeddings through its attention layers and feed-forward layers to produce a latent representation of the design. In a text-to-image architecture, the generative AI model then generates a latent image representation that is decoded into a bitmap image.

The server controls sampling parameters such as temperature and top-p to ensure that image generation is stable and reproducible for similar prompt sentences. The server records model configuration parameters such as model version, sampling parameters, and random seeds in association with the final prompt sentence. This leads to a technical effect: when a user issues a similar request at a later time, the server can reuse previous parameters to recreate a similar design image without repeated trial-and-error, thereby reducing inference time and server load.

Because the server constructs a prompt sentence with higher information content and reduced ambiguity, the generative AI model requires fewer iterations to produce a design image acceptable to the user. This directly reduces the number of inference calls and the amount of GPU time consumed, providing an improvement in computational efficiency and network bandwidth usage. The reduction in redundant inference operations and data transfers represents an improvement to computer technology, rather than mere automation of human design work.

H. Distinction from Human Operations and Non-Conventional Processing

The server performs several operations that are not simply equivalent to a human designer interpreting a text description. The server encodes sensitivity-related information into numerical vectors and integrates these vectors with syntactic and semantic information before constructing the prompt sentence. The server applies machine-learning-based extraction of preference patterns and usage contexts, which allows it to apply non-obvious combinations of attributes. For example, the server can infer that a “calm office interior” combined with “creative work” may require both neutral base colors and specific accent colors to balance concentration and creativity, and encode this into the prompt sentence automatically.

The server additionally maintains a history of prompt sentences and design images and may cluster them based on feature vectors. The server can thereby suggest modifications or default attributes based on similarities in feature space, which is not a conventional direct mapping from user text to images. This clustering and retrieval mechanism further increases accuracy and reduces processing time for recurring design patterns.

### I. Variations and Alternative Embodiments

The server may employ different types of generative AI models. In one variation, the server uses a text-to-text generative model to generate a refined prompt sentence and then passes this prompt sentence to a separate image generation model such as a diffusion model. In another variation, the server uses a multi-modal generative model that directly outputs both a design image and an explanatory text. In each case, the server's prompt generation and feature extraction modules are used to structure the input to the model in a technically advantageous way.

The server may deploy the generative AI model on-premise or in a cloud computing environment. The server may use different communication protocols between the server and the model-serving infrastructure, such as a remote procedure call protocol or a message queue. The terminal may be realized as a web browser executing client-side scripts instead of a native application.

In an alternative embodiment, the terminal executes a lightweight version of the natural language processing module. The terminal performs initial tokenization and language identification and sends intermediate features to the server. The server then completes deeper analysis and prompt generation. This distribution of processing can reduce network load and server CPU utilization in environments with a large number of concurrent users.

In another embodiment, the server applies post-processing on design images, such as automatic cropping or resolution adjustment, based on metadata in the feature vector.

Because the server stores usage-purpose information explicitly, it can automatically adjust image resolution and aspect ratio to match the intended use, such as wallpaper, poster, or icon, thereby avoiding manual resizing operations.

By integrating these modules and procedures, the server and the terminal collectively realize a system in which prompt sentences for a generative AI model are generated, refined, and utilized in a technically structured way. This results in higher-quality design images, improved inference efficiency, reduced communication overhead, and enhanced control over AI-generated content, thereby constituting an improvement in computer technology rather than a mere automation of a mental or artistic process.

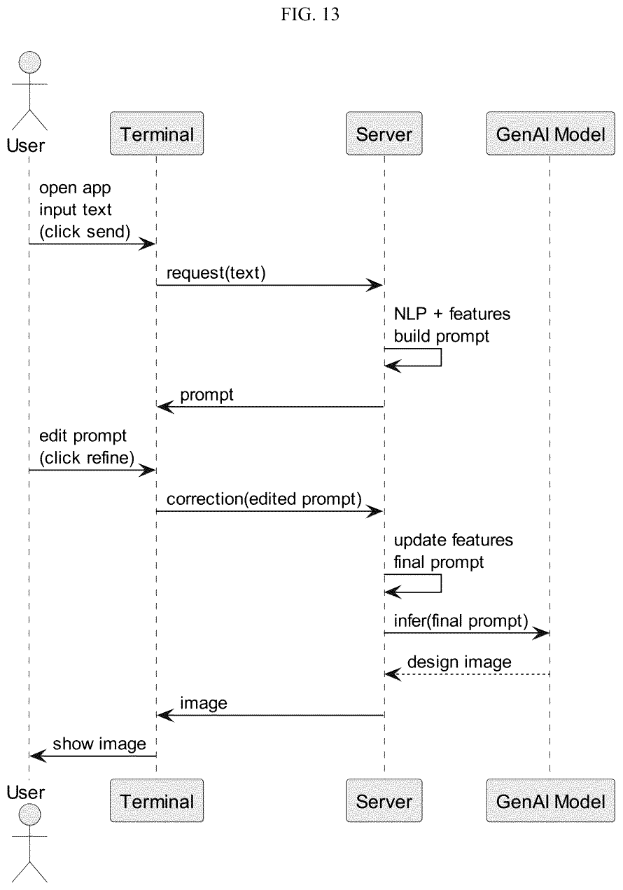

The following describes the processing flow using FIG. 13.

### Step 1

User operates the terminal to launch a design support application and to open a request input screen.

User inputs character information describing a desired design, such as “a bright floral pattern with a modern feel” or “a calm office interior that helps concentration,” into a text field and confirms the input by pressing a submit button.

Input: free-form natural language text describing a desired design.

Output: confirmed character information held in the terminal's memory for transmission.

### Step 2

Terminal receives the confirmed character information from the user interface component and validates it (for example, checks that the length is within a predetermined limit and that the text is not empty).

Terminal generates request information by combining the character information with communication control information such as a user identifier, a request identifier, a timestamp, and a language code.

Terminal serializes this request information into a structured format and transmits it to the server via a secure network connection.

Input: confirmed character information and locally available identifiers.

Output: structured request information transmitted to the server.

### Step 3

Server receives the request information via a communication interface and deserializes it to extract the character information and associated control fields.

Server performs initial validation, including verification of the user identifier and request identifier and checking for proper encoding and length of the character information.

If the validation is successful, server registers a new record in a database, storing at least the user identifier, request identifier, timestamp, and raw character information.

Input: structured request information from the terminal.

Output: validated character information stored in a database and passed to a natural language processing module.

### Step 4

Server executes natural language processing on the character information by invoking a text analysis module.

Server tokenizes the character information into tokens, assigns part-of-speech tags, and computes dependency relations to obtain syntactic information.

Server performs semantic analysis to detect entities such as objects (for example, “office,” “flowers”), materials (for example, “wood,” “fabric”), and style descriptors (for example, “modern,” “minimalist”), and groups them into categories.

Server analyzes sensitivity-related information by mapping adjectives and adverbs related to mood and preference to internal atmosphere vectors, preference flags, and usage-purpose categories.

Input: raw character information.

Output: feature information including syntactic information, semantic information, and sensitivity-related information stored as a structured feature vector associated with the request.

### Step 5

Server constructs a design prompt sentence on the basis of the feature information and the original character information.

Server selects a template structure that includes slots for mood, object category, materials, color scheme, spatial arrangement, and style.

Server fills the slots with values derived from the feature vector; if a slot is undefined, server uses default parameters determined by predefined rules or statistical priors.

Server generates continuous text by concatenating template segments and inserting appropriate articles and conjunctions, thereby forming a grammatically correct and detailed prompt sentence.

Input: feature vector and original character information.

Output: design prompt sentence suitable as input to a generative AI model.

### Step 6

Server stores the generated design prompt sentence together with the corresponding feature vector and request identifier in the database.

Server transmits the design prompt sentence to the terminal as part of a response message.

Terminal receives the response, parses it, and updates the user interface screen to display the design prompt sentence in an editable text area.

Input: design prompt sentence generated on the server.

Output: design prompt sentence displayed to the user on the terminal.

### Step 7

User reviews the displayed design prompt sentence and compares it with the original intention.

User optionally edits parts of the design prompt sentence, such as adding “with gold accents,” changing “bright pink” to “deep red,” or specifying “smaller flowers.”

User confirms the edited content by pressing a refinement or confirm button on the terminal.

Input: displayed design prompt sentence.

Output: edited prompt text representing a correction result.

### Step 8

Terminal receives the edited text from the user interface and packages it as a correction result, including the original request identifier and the edited prompt sentence.

Terminal transmits this correction result to the server via the communication interface.

Input: edited prompt sentence and request identifier.

Output: structured correction result message sent to the server.

### Step 9

Server receives the correction result and links it to the original request record using the request identifier.

Server re-applies natural language processing to the edited prompt sentence to extract updated feature information, focusing on differences between the original and edited text.

Server updates the previous feature vector by replacing attributes that correspond to edited portions and preserving attributes that were not changed, thereby minimizing redundant computations.

Input: correction result containing the edited prompt sentence.

Output: updated feature vector and an updated or confirmed final prompt sentence.

### Step 10

Server designates the updated prompt sentence as a final prompt sentence for the generative AI model.

Server tokenizes the final prompt sentence with a tokenizer compatible with the generative AI model and converts tokens into numerical token identifiers.

Server prepares model inference parameters such as maximum token length, temperature, top-p value, and random seed.

Input: final prompt sentence and model configuration parameters.

Output: tokenized representation and inference configuration supplied to the generative AI model.

### Step 11

Server feeds the tokenized final prompt sentence into the generative AI model deployed on a computing node including a processor and a hardware accelerator.

Generative AI model processes the token sequence through its embedding layer, attention layers, and feed-forward layers to generate a latent representation of the design.

Generative AI model decodes the latent representation into a design image in a digital image format.

Server receives the generated design image and associates it with the final prompt sentence and request identifier in the database.

Input: tokenized final prompt sentence and inference parameters.

Output: generated design image stored and ready for presentation.

### Step 12

Server sends the generated design image to the terminal together with metadata such as image resolution and associated final prompt sentence.

Terminal receives the image data, decodes it if necessary, and renders it on the display device in an image viewing area alongside the final prompt sentence.

User observes the generated design image and, if desired, initiates a further iteration of refinement by editing the prompt sentence again, or saves the design image as a finalized output.

Input: generated design image and associated metadata.

Output: design image visually presented to the user and optionally stored or reused in subsequent refinement cycles.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented design generation systems that use a generative AI model typically accept a single natural language request, directly pass that request as a simple prompt sentence to a generative model for image or layout generation, and then display a one-shot result. Such systems have several technical limitations.

First, the processing pipeline on the server side does not structurally separate and integrate heterogeneous input signals, such as natural language text and emotion-related information (for example, facial expressions or voice tone captured at the client device). As a result, the server generally treats the input as a flat text string, without converting it into structured design specification information that can be reliably reused, analyzed, and iteratively updated. This leads to unstable behavior of the generative AI model, because minor variations in wording of the prompt sentence may cause large, unpredictable changes in the generated design, thereby degrading the consistency and controllability of the system.

Second, conventional systems are not configured to maintain explicit associations among the user's successive requests, the intermediate prompt sentences, and the versions of generated image data. In many implementations, each generation request is handled as an independent transaction, and the server does not manage version information or store detailed model operation conditions together with the resulting image. Consequently, when the user provides iterative modification requests (for example, “make the background darker,” “make the logo smaller”), the server cannot systematically reconstruct or refine the internal design specification for the same design session. The lack of version-controlled prompt management forces the server to re-interpret each modification request from scratch, often losing context and increasing computational overhead.

Third, most existing systems do not exploit historical correlations between emotion state information, user-approved designs, and features extracted from natural language input. The server does not analyze past approval results as learning data for optimizing subsequent prompt generation. Therefore, the prompt construction logic remains static, does not adaptively learn which combinations of attributes and emotion states lead to higher user satisfaction, and cannot improve the quality and relevance of generated designs over time.

This results in repetitive server-side computations and inefficient usage of generative AI resources, since the system repeatedly explores similar design spaces without leveraging accumulated interaction data.

Fourth, because the server is not configured to decomposedly generate an instruction sentence that includes a prompt sentence as a structured, model-ready input, the boundary between natural language understanding and generative model control is blurred. The server often embeds control parameters implicitly in free-form user text, which complicates server-side validation, safety filtering, and optimization of prompt content. This limitation makes it difficult to implement robust server logic that enforces design domain constraints (e.g., design type, aspect ratio, content restrictions) and that can be reliably scaled or audited.

Accordingly, there is a need for an improved computer-implemented system in which a server processor is configured (i) to convert user input and emotion-related information into structured design specification information; (ii) to generate and maintain an instruction sentence including a prompt sentence as a stable interface to downstream generative models; (iii) to manage prompt sentences, image data, and version information in an integrated manner for iterative regeneration; and (iv) to analyze historical approval results and emotion state information to dynamically optimize prompt generation logic. Such improvements are directed to enhancing the technical performance, controllability, and adaptability of the generative design pipeline executed by the server, rather than merely automating a human design workflow.

The specific processing by the specific processing unit 290 of the data processing device 12 in Application Example 2 is realized by the following means.

The present invention provides a server comprising a processor configured to receive, via an information input/output apparatus, input information including a design request expressed in a natural language and emotion-related information, analyze natural language text included in the input information by performing language analysis processing to convert the natural language text into feature information, analyze the emotion-related information by performing emotion analysis processing to convert the emotion-related information into emotion state information, generate design specification information by integrating the feature information and the emotion state information, operate a generative artificial intelligence model for text generation using the design specification information as input so as to generate an instruction sentence including a prompt sentence to be used as input to a generative model for image generation or layout generation, input the instruction sentence to the generative model so as to cause the generative model to generate visual content based on the instruction sentence and acquire image data as a generation result, store the image data in a storage apparatus together with related information including the instruction sentence and model operation conditions, transmit the image data and the corresponding instruction sentence to the information input/output apparatus for display, receive from the information input/output apparatus a modification request from a user for the displayed image data, update at least one of the design specification information and the instruction sentence based on the modification request, perform a regeneration process by the generative model using an updated instruction sentence in a repeatable manner, store in the storage apparatus a final version of the image data approved by the user together with an association among the final version of the image data, the instruction sentence used for generating the final version of the image data, and the model operation conditions, analyze past approval results and corresponding emotion state information and feature information as learning data, and adjust weighting or priority applied to the design specification information based on an analysis result of the learning data so as to dynamically optimize contents of generation of the instruction sentence including the prompt sentence for future generation processing. This enables the server to execute a more stable and controllable generative design pipeline in which heterogeneous input signals are converted into structured design specification information and an instruction sentence serving as a standardized interface to a generative AI model, iterative modifications are managed by version-controlled associations between prompt sentences and image data, and prompt generation logic is adaptively tuned using historical approval and emotion data, thereby improving the efficiency, responsiveness, and output quality of computer-based design generation.

The term “information input/output apparatus” refers to an electronic device including at least one display component and at least one input component, such as a screen, keyboard, pointing device, touch panel, camera, or microphone, that enables a user to view information provided by a system and to provide input to the system.

The term “design request” refers to information indicating a desired visual content, such as an image or layout, the information being expressed in a natural language and including at least one requirement relating to a theme, style, object, or mood of the visual content.

The term “natural language text” refers to character data expressed in a human language, such as a sentence or phrase entered by a user, that is not constrained to a fixed command syntax and that is subject to language analysis processing.

The term “emotion-related information” refers to data indicative of a user's emotional state, including but not limited to data derived from facial expressions, voice characteristics, physiological signals, or explicit user input relating to mood.

The term “language analysis processing” refers to a sequence of computer-implemented operations that convert natural language text into structured data, the operations including at least one of tokenization, part-of-speech tagging, syntactic parsing, semantic analysis, or entity extraction.

The term “feature information” refers to structured data representing attributes extracted from a design request, including at least one of a design theme, color preference, style preference, target object, or desired mood, the data being derived from language analysis processing.

The term “emotion analysis processing” refers to a sequence of computer-implemented operations that analyze emotion-related information to estimate a user's emotional state, the operations including at least one of pattern recognition, signal processing, statistical analysis, or machine learning inference.

The term “emotion state information” refers to structured data representing an estimated emotional condition of a user, including at least one of an emotion category, an intensity value, or a confidence value.

The term “design specification information” refers to structured information generated by integrating feature information and emotion state information, the structured information describing, in a machine-interpretable form, requirements for generating visual content.

The term “generative artificial intelligence model for text generation” refers to a machine learning model configured to receive structured or unstructured input and to output text data, including at least one instruction sentence or prompt sentence, by performing probabilistic or neural sequence generation.

The term “instruction sentence” refers to text generated by a generative artificial intelligence model for text generation, the text specifying, in a structured natural language form, conditions for generating visual content by a generative model for image generation or layout generation.

The term “prompt sentence” refers to a portion of an instruction sentence that is used as a direct input to a generative model for image generation or layout generation, the portion representing a condensed natural language description of desired visual features.

The term “generative model for image generation or layout generation” refers to a machine learning model configured to receive an instruction sentence or prompt sentence and to output visual content such as an image, graphic arrangement, or page layout by performing generative inference.

The term “visual content” refers to data representing at least one visual element, such as an illustration, photograph-like image, graphic pattern, or layout arrangement, that can be displayed on a display screen.

The term “image data” refers to digital data representing visual content in a raster or vector format that is suitable for storage, transmission, and display by an electronic device.

The term “storage apparatus” refers to a hardware and software combination including at least one memory device or persistent storage device and a control mechanism, the combination being configured to store and retrieve data such as image data, instruction sentences, and model operation conditions.

The term “related information” refers to data stored in association with image data, the data including at least one of an instruction sentence, design specification information, model operation conditions, user identification information, timestamp information, or version information.

The term “model operation conditions” refers to parameters used to control execution of a generative model, including at least one of a model identifier, random seed, inference step count, sampling method, resolution setting, or style parameter.

The term “modification request” refers to user-provided information indicating a desired change to already-generated visual content, the information being expressed as natural language text, operation information, or both, and specifying at least one adjustment to a design attribute.

The term “operation information” refers to non-textual input obtained from user interaction with a user interface, including at least one of slider movements, button selections, drag-and-drop actions, or menu selections indicating changes to design parameters.

The term “regeneration process” refers to a sequence of operations in which an updated instruction sentence is input to a generative model for image generation or layout generation to produce new image data that reflects at least one modification request.

The term “final version of the image data” refers to image data that has been generated through one or more regeneration processes and has been explicitly approved or confirmed by a user as satisfying the user's requirements.

The term “past approval results” refers to historical records indicating which versions of image data were accepted or rejected by a user, the records being stored in association with corresponding instruction sentences, design specification information, and emotion state information.

The term “learning data” refers to a dataset composed of past approval results, corresponding feature information, and corresponding emotion state information, the dataset being used as input for analysis to adjust prompt generation behavior.

The term “weighting or priority applied to the design specification information” refers to numerical or logical parameters that influence the relative importance of attributes within the design specification information when generating an instruction sentence.

The term “version information” refers to data that identifies and orders different states of instruction sentences or image data within a sequence of iterative changes, including at least one identifier, revision index, or timestamp indicating a version history.

In one embodiment, a server implements the claimed system by executing software modules on general-purpose computing hardware. The server includes at least one processor, a main memory, a non-volatile storage device, a network interface, and optionally one or more graphics processing units. The server executes an operating system such as a general-purpose operating system and runs application software implemented, for example, in a high-level programming language. The server communicates with one or more terminals over a network such as the Internet using a communication protocol such as HTTPS.

A terminal is implemented as a user device such as a smartphone, tablet, or personal computer that includes at least one display, at least one input component such as a touch panel, keyboard, mouse, camera, or microphone, and a network interface. The terminal executes a client application implemented using a user interface framework such as a mobile application framework or a web browser framework. The user operates the terminal to input natural language text and other information.

The server provides, to the terminal, an interface that enables the user to enter a design request expressed in a natural language. The terminal displays a screen including a text input field and various controls for selecting a design type, such as an advertising layout, a clothing design, or another visual content type. The terminal sends input information to the server as a structured message including at least natural language text, a design type identifier, and optionally emotion-related information such as video frames from a camera or audio data from a microphone.

The server includes a language analysis module, an emotion analysis module, a design specification management module, a generative AI text module, a generative image or layout module interface, a storage management module, and a history learning module. These modules are implemented as executable components running on the processor and cooperating via defined data structures stored in the main memory.

The server uses the language analysis module to perform language analysis processing on the natural language text. The language analysis module is implemented, for example, using a natural language processing library such as a tokenization and parsing library. The language analysis module converts the natural language text into feature information by applying a sequence of operations including tokenization, part-of-speech tagging, dependency parsing, and semantic role labeling. The language analysis module extracts design-related attributes such as theme, style, color preference, target audience, and mood. The module represents these attributes in a structured data format, for example as a feature vector or key-value pairs, that form the feature information.

The server uses the emotion analysis module to perform emotion analysis processing on emotion-related information when such information is provided. The emotion analysis module receives input such as facial image frames or audio feature vectors and computes emotion state information. In one embodiment, the emotion analysis module uses a convolutional neural network to process facial images and a recurrent or transformer-based neural network to process audio features. The networks are trained to output an emotion category such as joy, sadness, or calm, along with an intensity score. The emotion analysis module converts these outputs into emotion state information represented as a structured vector or set of labels.

The server uses the design specification management module to integrate the feature information and the emotion state information to generate design specification information.

The design specification management module applies an explicit rule set and weighting mechanism. For example, the design specification management module assigns weights to attributes such as theme, palette, composition, and emotion. The design specification management module resolves conflicts, such as a textual indication of a “dark mood” and an emotion state of “joy,” by consulting a priority table or by applying a heuristic algorithm that assigns a higher weight to one source depending on a design type. The design specification management module generates design specification information as a structured object containing normalized attributes such as design_type, theme, color palette, style, motif_list, composition_preference, and emotion_label.

The server uses the generative AI text module to operate a generative AI model for text generation using the design specification information as input. The generative AI model is implemented as a neural network-based language model, for example a transformer encoder-decoder architecture trained on design-related text data. The generative AI text module converts the design specification information into an input sequence by concatenating serialized attributes and feed them into the generative model. The generative AI model outputs an instruction sentence including a prompt sentence to be used as input to a generative image or layout model. The instruction sentence is structured to explicitly encode design constraints, such as design type, required elements, mood, and style hints.

The server can generate prompt sentences such as:

“A vivid, joyful T-shirt design featuring a lush green forest, a bright blue sky, and colorful flowers, expressing a cheerful and energetic mood.”

“A colorful summer beach T-shirt design with blue ocean, white sand, and bright surfboards, expressing a joyful and energetic mood.”

“A pastel-colored summer beach T-shirt design with soft blue ocean, light sand, and gentle surfboards, maintaining a joyful but relaxed mood.”

“A pop, colorful, youth-oriented casual advertising banner with bold typography and a bright gradient background.”

“A relaxing blue-tone T-shirt design with soft waves and a calm, peaceful atmosphere.”

The server uses the generative image or layout module interface to input the instruction sentence or the prompt sentence to a generative model for image generation or layout generation. In one embodiment, the server communicates with an image generation model implemented as a latent diffusion-based generative model running on a GPU. The server encodes the prompt sentence using a text encoder network, such as a transformer encoder, to produce a text embedding. The server then executes an iterative denoising process on a latent representation, using the text embedding as a conditioning signal for each denoising step. The generative model outputs a latent image representation that the server decodes into image data. In another embodiment, the server communicates with an image generation service over an API, sending the prompt sentence and receiving raster image data.

The server may use a layout generator for advertising designs implemented as a combination of heuristic layout rules and a neural scoring network. The server parses the instruction sentence to identify text blocks, logo positions, and image areas. The server generates candidate layouts by applying rule-based composition algorithms and scores these candidates using a neural model that predicts readability and aesthetic quality. The server selects a high-scoring layout and renders it into image data using a graphics library.

The server uses the storage management module to store the image data and related information in a storage apparatus. The storage apparatus includes a persistent storage device and a database system. The server stores the image data in an object storage region and maintains a database record that associates the image data with the corresponding instruction sentence, design specification information, model operation conditions such as model identifier, sampling parameters, and random seed, and version information. The server transmits the image data and the corresponding instruction sentence to the terminal for display.

The user views the generated image on the terminal display and may issue a modification request. The terminal collects the modification request as natural language text or user interface operations such as slider adjustments or button selections. The terminal sends the modification request to the server as structured data, including a reference to the version of the image data to be modified.

The server uses the design specification management module to update at least one of the design specification information and the instruction sentence based on the modification request. The design specification management module parses the modification request text using the language analysis module and converts it into adjustment operations on the existing design specification information. For example, when the user inputs “make the background slightly darker and reduce the logo size,” the design specification management module updates the attributes background_brightness and logo_size. The generative AI text module then regenerates an instruction sentence and prompt sentence that reflect the updated design specification information while maintaining references to unchanged elements.

The server again calls the generative model for image generation or layout generation with the updated prompt sentence. The generative model produces new image data that incorporates the requested modifications. In the case of a latent diffusion-based model, the server can use an image-to-image mode in which the prior version of image data is encoded into a latent representation and then refined under the guidance of the updated prompt sentence. This configuration allows the system to preserve high-level composition while applying local or stylistic changes, thereby increasing stability and reducing artifacts.

The server repeats this regeneration process until the user approves a final version of the image data. When the user indicates approval, the server stores the final version of the image data in the storage apparatus together with an association between the final image data, the corresponding instruction sentence, the design specification information, and the model operation conditions. The storage management module maintains version information so that each iterative design state is preserved and identifiable. This explicit versioning enables traceability and rollback, improving reliability and auditability of the generative process.

The server uses the history learning module to analyze past approval results as learning data.

The history learning module retrieves stored entries including approved and rejected image versions, corresponding design specification information, emotion state information, and instruction sentences. The history learning module trains or updates a model that predicts user approval probability based on design specification attributes and emotion state. In one embodiment, the history learning module implements a gradient-boosted decision tree or a small neural network that outputs weight adjustments for specific attributes. The history learning module computes gradients of a loss function that penalizes mispredicted approvals, updates model parameters using an optimization algorithm such as stochastic gradient descent or an adaptive optimizer, and periodically recomputes attribute weight tables.

The server uses the resulting weight adjustments to modify how the design specification management module integrates feature information and emotion state information into design specification information. For example, when historical data shows that users with an emotion state of joy frequently approve bright color palettes and large motifs, the history learning module increases the weight for corresponding attributes under that emotion condition. This modification affects the generation of future instruction sentences and prompt sentences. As a result, the system adaptively adjusts prompt construction to reflect learned user preference patterns, thereby improving generation accuracy and reducing the number of regeneration iterations required to reach a satisfactory design.

This architecture produces technical effects that go beyond mere automation of human design work. By converting heterogeneous input signals into structured design specification information and by separating the generation of instruction sentences from the execution of generative models, the server achieves more stable and reproducible control of model behavior. The explicit data structures and rule-based conflict resolution mechanisms reduce variability in image outputs caused by small differences in user wording, resulting in lower error rates and improved consistency.

Furthermore, the use of version-controlled associations among prompt sentences, design specification information, emotion state information, and image data reduces redundant computation and network traffic. The server can reuse intermediate representations and selectively update only the attributes affected by a modification request. This partial update mechanism reduces the amount of data that must be transmitted between the server and the generative model and decreases the number of full regeneration cycles, thereby improving processing speed and reducing communication load.

The adaptive learning of attribute weights from historical approval results enhances computational efficiency and decision quality within the server. By biasing prompt generation toward historically successful attribute combinations, the server reduces the exploration space that the generative model must traverse. This leads to faster convergence to acceptable designs and reduces wasted computation on unlikely-to-be-approved designs.

The use of neural network architectures in the language analysis module, emotion analysis module, and generative AI text module is configured to improve performance of text understanding and prompt generation. For example, the generative AI text module can employ a transformer-based architecture with multi-head attention and positional encoding, trained with a maximum likelihood objective over design prompt corpora. The emotion analysis module can employ convolutional layers for spatial feature extraction in images and attention-based layers for temporal integration in audio signals. The history learning module can implement a feedforward network that processes design specification vectors and outputs adjustment coefficients, trained using a loss function based on approval prediction error.

These architectures and training methods yield improved robustness and adaptability compared to simple rule-based or linear models.

The server applies data augmentation techniques to training data collected from user interactions. For example, the server can generate paraphrased versions of design requests and simulated variations of emotion state labels to increase training diversity. The server can also augment image data by applying transformations such as cropping, scaling, and color jitter when training auxiliary scoring networks. Such augmentation reduces overfitting and improves generalization of models used for prompt generation and layout scoring.

In another embodiment, the server and terminal cooperate to reduce communication load. The server may transmit, in addition to raster image data, lightweight vector representations or hash identifiers of visual elements, which the terminal can combine with locally stored templates to render previews. This reduces image size and latency when iteratively updating designs. The server may also compress prompt sentences and use short identifiers referencing frequently used patterns.

The described system is not limited to clothing or advertising designs. The server can apply the same architecture to other types of visual content, such as product packaging, user interface screens, or decorative patterns. The design specification information and prompt sentence formats can be extended with additional attributes, such as resolution constraints, device targets, or accessibility requirements. The generative model interface can be connected to different types of generative AI models, such as vector graphics generators or three-dimensional model generators, by adapting the instruction sentence format and model operation conditions.

In yet another embodiment, the server does not require emotion-related information and instead uses only feature information derived from natural language text. Even in this configuration, the integration of structured design specification information, instruction sentence generation, version management, and history learning continues to provide technical benefits in terms of robustness, consistency, and efficiency of the generative pipeline. The system architecture allows the server to control the generative model via stable prompt sentences rather than raw user input, resulting in improved technical performance of the overall computer system.

Through these embodiments, the server, terminal, and user cooperate in a manner that provides a concrete improvement to computer-based design generation: the server implements specific data structures, model architectures, and algorithms that control and refine prompt sentences; the terminal provides structured interaction and capture of emotion-related data; and the user interacts with a responsive system that converges to acceptable designs with fewer iterations, reduced latency, and improved quality of results.

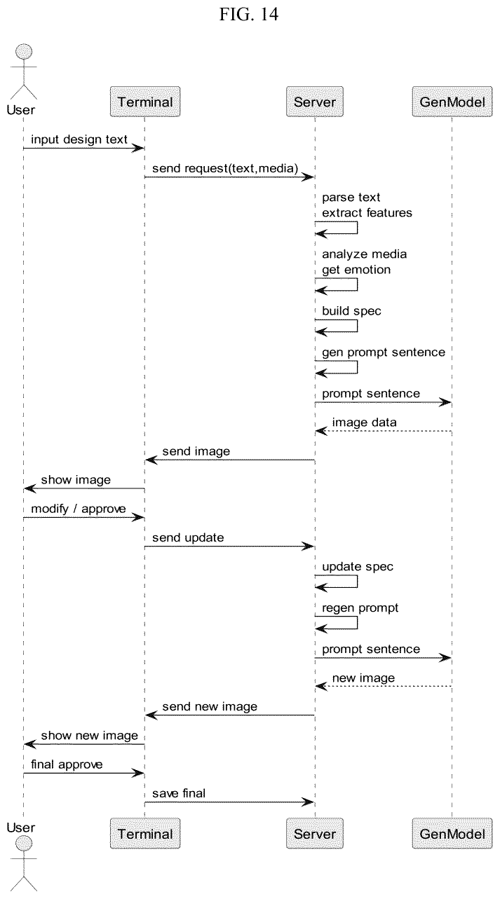

The following describes the processing flow using FIG. 14.

### Step 1

User operates the terminal to input a design request and optional emotion consent.

User enters natural language text such as “I want a colorful summer beach T-shirt design” into a text field on the terminal and optionally enables camera and microphone access.

Input: Free-form natural language text and user settings for emotion capture.

Output: UI state on the terminal including the entered text and flags indicating whether emotion capture is enabled.

### Step 2

Terminal captures input data and constructs a request payload.

Terminal reads the text from the input field, reads control states such as design type (e.g., “tshirt”, “advertisement”), and, when enabled, activates the camera and microphone to capture short video frames and audio segments while the user is speaking or confirming the request. Terminal compresses the media data (e.g., encoding images into JPEG, audio into a compressed waveform) and packages the text, design type, and any media data into a structured data object.

Input: User text, control states, raw camera frames, and raw audio samples.

Output: A structured payload (for example, a JSON object plus binary media) including fields such as ‘user_text’, ‘design_type’, and optional encoded media.

### Step 3

Terminal transmits the request payload to the server.

Terminal sends the payload to a predefined server endpoint over a secure network connection using a protocol such as HTTPS. Terminal attaches authentication tokens if required and waits for a response.

Input: Structured request payload prepared in Step 2.

Output: A network request message delivered to the server and a pending response state on the terminal.

### Step 4

Server receives and validates the incoming request.

Server accepts the network connection, parses the payload, and validates mandatory fields such as ‘user_text’ and ‘design_type’. Server checks payload size, allowable media formats, and authentication. If any validation fails, server constructs an error response; otherwise, server passes the parsed request to internal modules for processing.

Input: Network message containing the structured payload.

Output: An internal request object stored in memory, containing validated text, design type, and optional media references.

### Step 5

Server performs language analysis processing to extract feature information.

Server passes the natural language text from the request object to a language analysis module.

The module tokenizes the text into tokens, assigns part-of-speech tags, and runs a parser to identify phrase structures. Server then applies semantic analysis to detect attributes such as theme (“summer beach”), palette (“colorful”), and item type (“T-shirt”). Server represents these attributes in a structured form, such as key-value pairs or a feature vector.

Input: Natural language text contained in the internal request object.

Output: Feature information representing extracted attributes, for example a data structure such as ‘{theme: ‘summer beach’, palette: ‘colorful’, item: ‘tshirt’}’.

### Step 6

Server performs emotion analysis processing to generate emotion state information.

Server passes any captured media from the request object to an emotion analysis module. For image frames, server feeds pixel arrays into a convolutional network; for audio, server computes features such as Mel-frequency cepstral coefficients and feeds them into a temporal network. The module outputs probabilities for multiple emotion categories (e.g., joy, sadness, calm). Server selects the highest-probability category and its intensity and stores this as emotion state information.

Input: Encoded video frames and/or audio segments extracted from the internal request object.

Output: Emotion state information, such as ‘emotion_label=‘joy’’ and ‘emotion_intensity=0.85’.

### Step 7

Server generates design specification information by integrating features and emotion.

Server calls a design specification management module with the feature information and emotion state information. The module applies predetermined rules and weights: for example, it may increase the weight of bright palettes when ‘emotion_label=‘joy’’. Server resolves conflicts between textual features and emotion-based tendencies according to a priority table.

Server then creates a unified design specification object that includes normalized attributes for theme, style, palette, motifs, layout preferences, and emotion.

Input: Feature information from Step 5 and emotion state information from Step 6.

Output: Design specification information, such as {design_type: ‘tshirt’, theme: ‘summer beach’, palette: ‘colorful’, emotion: ‘joy’, motifs: [‘ocean’, ‘sand’, ‘surfboard’]}”.

### Step 8

Server generates an instruction sentence including a prompt sentence using a generative AI model.

Server supplies the design specification information to a generative AI text module that wraps a transformer-based language model. Server serializes the specification into a token sequence (for example, “design_type=tshirt; theme=summer beach; palette=colorful; emotion=joy; motifs=ocean, sand, surfboard”) and feeds the tokens into the model. The model performs attention-based computation over the sequence and generates text with a next-token prediction algorithm. Server decodes the output tokens into an instruction sentence that contains a prompt sentence suitable for an image or layout generative model.

Input: Design specification information from Step 7.

Output: An instruction sentence including a prompt sentence, for example: “A colorful summer beach T-shirt design with blue ocean, white sand, and bright surfboards, expressing a joyful and energetic mood.”

### Step 9

Server performs post-processing of the instruction sentence.

Server checks the generated instruction sentence for prohibited content, required mentions of the design type, and length constraints. Server trims redundant phrases and, if configured, appends technical qualifiers such as “high resolution, centered composition” to the prompt sentence. Server stores the finalized instruction sentence and prompt sentence in a temporary context object linked to the design session.

Input: Raw instruction sentence generated in Step 8.

Output: A sanitized, model-ready instruction sentence including a refined prompt sentence and associated metadata in the context object.

### Step 10

Server invokes a generative model for image or layout generation using the prompt sentence.

Server selects a generative model based on the design type (for example, a diffusion image model for T-shirt designs or a layout generator for advertisements). Server passes the prompt sentence and generation parameters such as resolution, number of inference steps, and random seed to the model interface. For a diffusion model, server encodes the prompt into an embedding, initializes a random latent tensor, and iteratively denoises the latent tensor conditioned on the embedding.

Input: Finalized prompt sentence and generation parameters from the context object.

Output: A latent or direct representation of visual content produced by the generative model.

### Step 11

Server decodes and formats the generated visual content as image data.

Server converts the latent representation into a pixel image using a decoder network if a latent diffusion model is used. Server then applies image processing operations such as resizing to target dimensions, color correction, and compositing onto a mockup template (e.g., placing the design onto a T-shirt outline or banner frame). Server encodes the resulting bitmap into a file format such as PNG or JPEG with specified compression.

Input: Visual content representation from Step 10.

Output: Encoded image data representing the generated design.

### Step 12

Server stores the generated image data and related information.

Server writes the image file to a storage subsystem and records in a database the association between the stored image, the instruction sentence, the design specification information, model identifiers, and version identifiers. Server sets an initial version tag (for example, “v1”) and marks the status as “draft_generated.”

Input: Encoded image data from Step 11 and associated context (instruction sentence, design specification information, model parameters).

Output: Persistent storage records including an image location (such as a URL), configuration data, and version metadata.

### Step 13

Server returns the generated design to the terminal.

Server constructs a response object that includes the image location, the instruction sentence, and design metadata such as design type and creation time. Server sends the response over the network to the terminal.

Input: Database record and image location from Step 12.

Output: A response message delivered to the terminal that contains all data necessary to display the generated design.

### Step 14

Terminal displays the generated design to the user.

Terminal parses the response, retrieves the image from the specified location if needed, and renders it on the display along with explanatory text such as the instruction sentence or a summary of the design specification. Terminal may present multiple variations as separate preview tiles.

Input: Response message from Step 13 and image data retrieved from storage or network.

Output: A visual presentation of the generated design on the terminal screen and an updated UI state ready to accept feedback.

### Step 15

User reviews the generated design and provides a modification request.

User examines the displayed image and, if unsatisfied, inputs additional natural language instructions such as “Make the colors slightly more pastel” or adjusts UI controls such as color sliders and motif size selectors. User confirms the modification request via a submission control.

Input: Visual display of the design and UI controls on the terminal.

Output: New user-provided modification text and/or interaction data to be processed by the terminal.

### Step 16

Terminal encodes and transmits the modification request to the server.

Terminal collects the modification text and operation information, associates it with the existing design version identifier (e.g., “v1”), and creates an update payload specifying which design is to be modified. Terminal sends this payload to the server via the network.

Input: User modification text, operation information, and design version identifier from Step 15.

Output: An update request message delivered to the server.

### Step 17

Server updates design specification information and regenerates an instruction sentence.

Server retrieves the stored design specification information and instruction sentence for the referenced design version. Server applies language analysis to the modification text, interprets operation information, and updates specific attributes such as color palette or motif scale in the design specification information. Server then calls the generative AI text module again, providing the updated specification, to produce a revised instruction sentence and prompt sentence, for example: “A pastel-colored summer beach T-shirt design with soft blue ocean, light sand, and gentle surfboards, maintaining a joyful but relaxed mood.”

Input: Existing design specification information, existing instruction sentence, and modification request data from Step 16.

Output: Updated design specification information and a revised instruction sentence including a revised prompt sentence.

### Step 18

Server regenerates an updated design using the revised prompt sentence.

Server invokes the generative model again, this time providing the revised prompt sentence and optionally the existing image as a reference for image-to-image refinement. Server runs the generative algorithm to produce new visual content consistent with the modifications while preserving desired aspects of the original design.

Input: Revised prompt sentence and, optionally, previous image data.

Output: New image data representing an updated version of the design.

### Step 19

Server stores the updated design as a new version and returns it to the terminal.

Server encodes and stores the new image, updates the database with a new version identifier (for example, “v2”), and links it to the same design session. Server then sends the new image location and updated metadata back to the terminal, marking it as a new draft for user review.

Input: New image data from Step 18 and existing design session records.

Output: Updated storage records and a response message enabling the terminal to display the new version.

### Step 20

User either iterates further modifications or approves a final version.

User views the updated design on the terminal. If necessary, user repeats Steps 15 and 16 with further instructions; if satisfied, user indicates approval via a confirmation control.

Input: Display of updated design version from Step 19.

Output: Either additional modification requests or an approval signal indicating the final version.

### Step 21

Server finalizes and records the approved design.

Server receives the approval signal and marks the associated design version as final in the database. Server stores a final association of the approved image data, the corresponding instruction sentence, the design specification information, and model operation conditions.

Server may also trigger downstream processes such as exporting the design for production or archiving for later retrieval.

Input: Approval signal and current design session state from Step 20.

Output: Finalized design records in storage and, optionally, downstream artifacts for further technical use.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

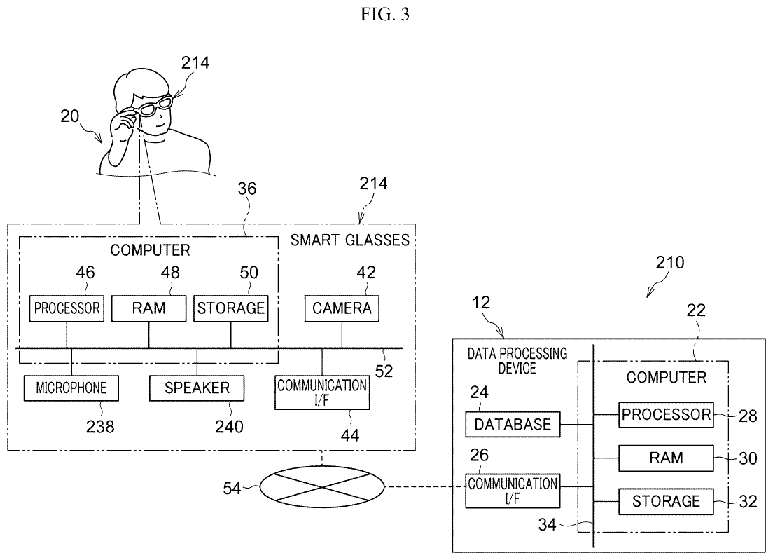

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

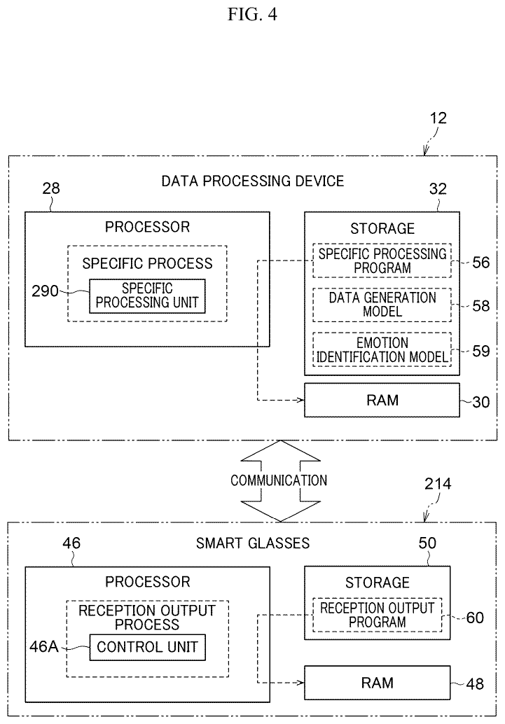

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

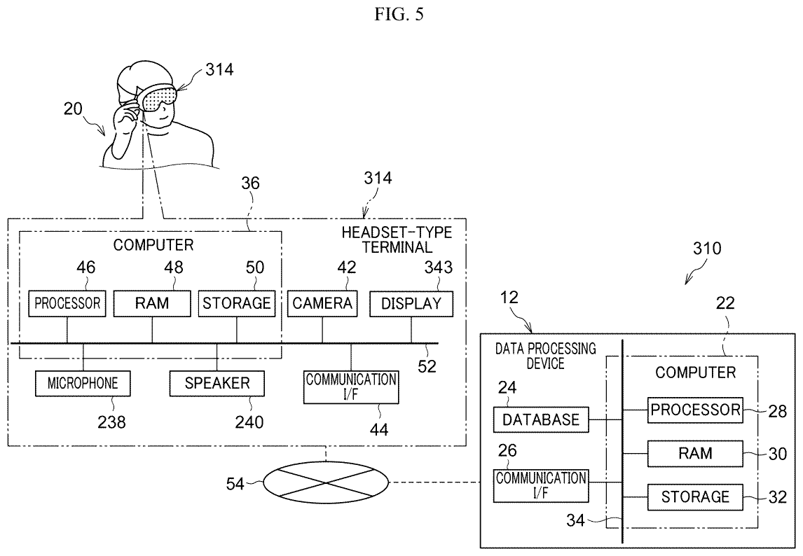

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

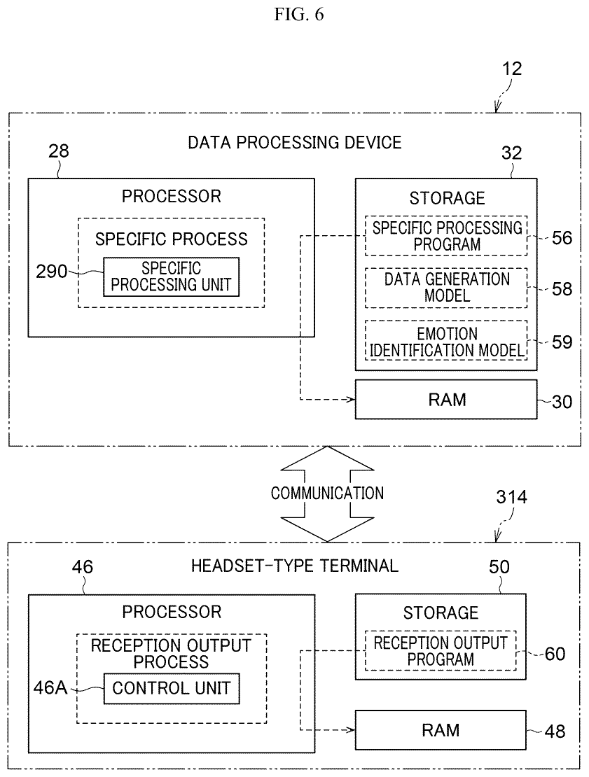

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

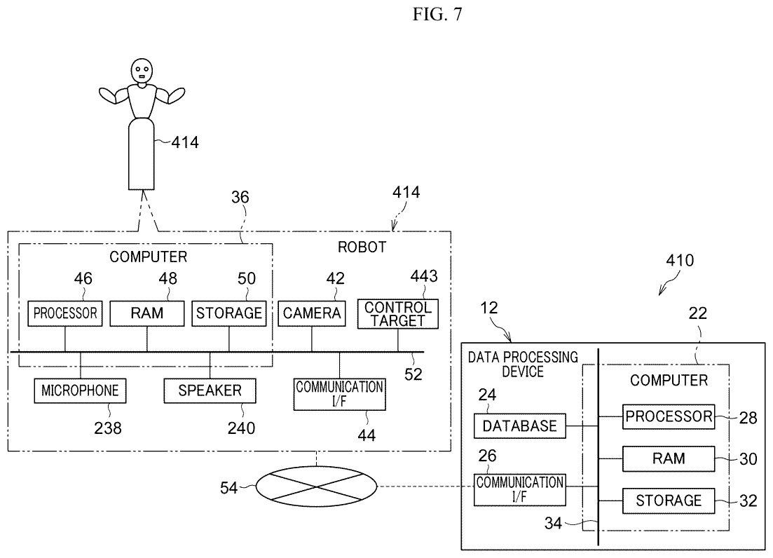

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

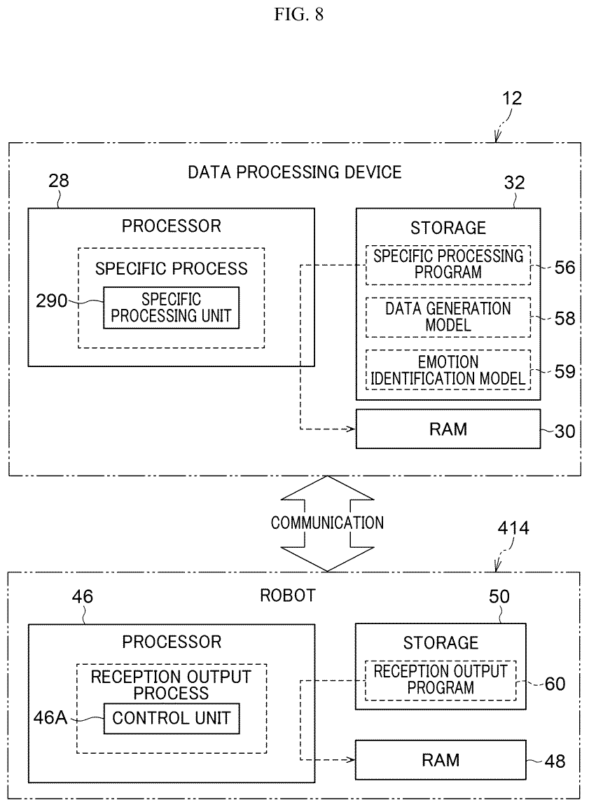

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

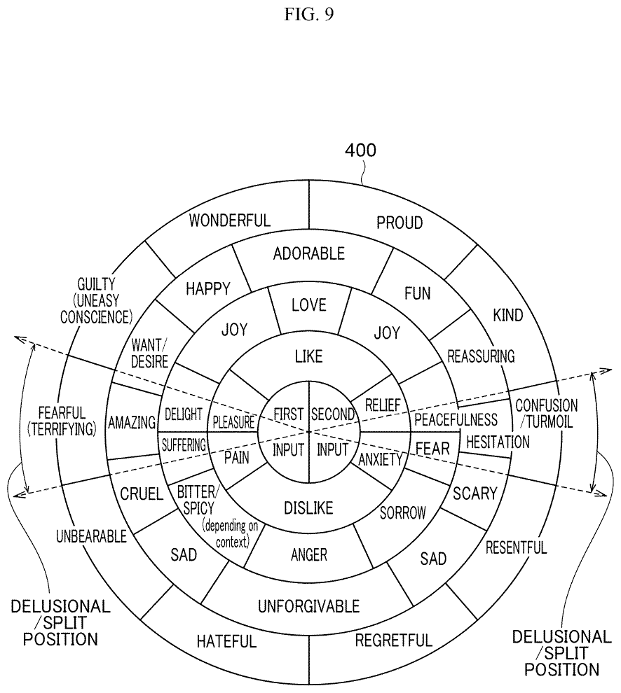

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

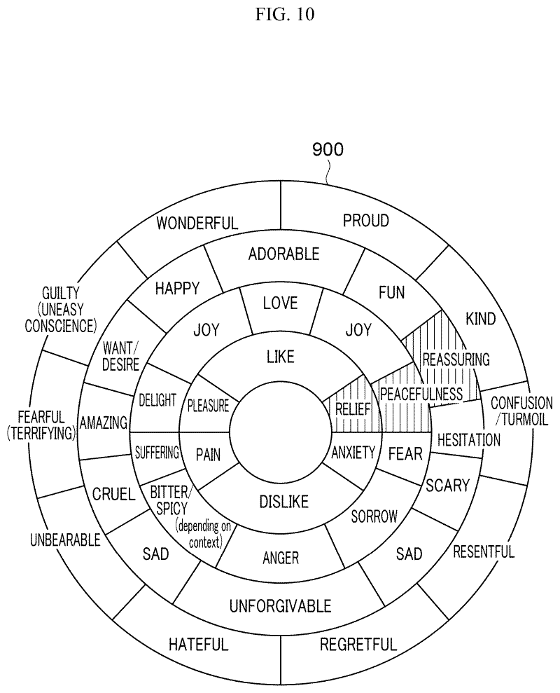

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide to an information processing apparatus an input/output interface for receiving character information including user state information or user preference information, and analyze the character information by natural language processing to extract feature information indicating an emotional state or a preference attribute of a user,
generate structured information including the feature information, generate an instruction sentence based on the structured information by template processing or character string processing so as to instruct a generative AI model to generate a visual composition, and convert the instruction sentence into a prompt sentence as request data transmittable to the generative AI model,
and transmit the request data to the generative AI model via a communication network, acquire visual composition data from the generative AI model, display the visual composition data to the user via the input/output interface, receive additional evaluation information or modification request information from the user again as the character information, and
repeatedly execute the natural language processing and the generation of the instruction sentence.

### Supplementary 2

The system according to supplementary 1,
wherein the processor is configured to include, in the structured information, the emotional state information, color tone attribute information, and subject attribute information extracted from the character information as the feature information, and generate the instruction sentence so as to generate the prompt sentence reflecting the feature information.

### Supplementary 3

The system according to supplementary 1,
wherein the processor is configured to store, in a storage device, the visual composition data acquired from the generative AI model in association with identification information, and
store, in association with each other, final visual composition data selected by the user via the input/output interface, the prompt sentence, and the feature information.

### Application Example 1

### Supplementary 1

A system comprising a processor,
wherein the processor is configured to
provide a user interface via an information processing terminal to receive input information including a mood and a preference of a user, and to acquire the input information from the information processing terminal,
analyze mood information and preference information included in the input information, extract product attribute information and category information corresponding to the mood information and the preference information, and generate a prompt sentence that instructs a generative artificial intelligence model to generate a product recommendation based on the product attribute information and the category information,
input the generated prompt sentence into the generative artificial intelligence model and acquire product proposal information generated by the generative artificial intelligence model based on the prompt sentence, and
convert the product proposal information into structured data, transmit the structured data to the information processing terminal, and output, via the user interface, product information to be presented to the user.

### Supplementary 2

The system according to supplementary 1,
wherein the processor is configured to
execute natural language processing on the input information to extract expressions representing the mood information and the preference information, and apply the expressions to a template to generate the prompt sentence including an instruction content specifying an output format and a number of product proposals for the generative artificial intelligence model.

### Supplementary 3

The system according to supplementary 1,
wherein the processor is configured to
divide the product proposal information in natural language, acquired from the generative artificial intelligence model, into individual items, map each item to structured data including a product identifier and a product description, and transmit the structured data as the product information to the information processing terminal.

### Example 2

### Supplementary 1

A system comprising a processor,
wherein the processor is configured to
provide, to a terminal device, a user interface screen for receiving, as character information, a user request related to a design, and acquire the character information from the user interface screen of the terminal device, convert the acquired character information into request information including at least the character information and communication control information, and receive the request information from the terminal device via a communication network,
execute natural language processing on the character information included in the request information to extract feature information including at least syntactic information, semantic information, and sensitivity-related information, and generate, on the basis of the extracted feature information and the character information, a design prompt sentence to be input to a generative AI model,
transmit the generated design prompt sentence to the terminal device, and cause the terminal device to display the design prompt sentence on the user interface screen so as to receive confirmation and correction input from the user, and receive, from the terminal device, a correction result of the design prompt sentence input by the user,
determine, on the basis of the correction result, a final prompt sentence as an input sentence to the generative AI model, input the final prompt sentence to the generative AI model so as to cause the generative AI model to generate a design image corresponding to the final prompt sentence, and acquire the generated design image, and
cause at least one of the terminal device and a storage apparatus to present the generated design image on the user interface screen and store the generated design image as a recording target.

### Supplementary 2

The system according to supplementary 1,
wherein the processor is configured to
analyze, in the natural language processing, sensitivity-related information including at least atmosphere information, preference information, and usage-purpose information extracted from the character information, and add, to the design prompt sentence, visual expression elements, color scheme elements, and composition elements reflecting the sensitivity-related information so as to concretize an expression direction of the design image to be generated by the generative AI model.

### Supplementary 3

The system according to supplementary 1,
wherein the processor is configured to
control the terminal device to display the design prompt sentence or the final prompt sentence as an editable character input area in the user interface screen, and receive, from the terminal device, edited content input by the user and retransmitted to the processor, thereby iteratively updating generation processing of the design image by the generative AI model on the basis of the edited content.

### Application Example 2

### Supplementary 1

A system comprising a processor,
wherein the processor is configured to
provide, on an information input/output apparatus, a display screen and an input field for receiving a design request expressed in a natural language from a user, and receive input information including the design request and emotion-related information acquired together with the design request,
analyze natural language text included in the input information by performing language analysis processing so as to convert the natural language text into feature information, analyze the emotion-related information by performing emotion analysis processing so as to convert the emotion-related information into emotion state information, and generate design specification information by integrating the feature information and the emotion state information,
operate a generative artificial intelligence model for text generation using the design specification information as input so as to generate an instruction sentence including a prompt sentence to be used as input to a generative model for image generation or layout generation,
input the instruction sentence to the generative model for image generation or layout generation so as to cause the generative model to generate visual content based on the instruction sentence, and acquire a generation result of the generative model as image data, store the image data in a storage apparatus together with related information, and transmit the image data and the corresponding instruction sentence to the information input/output apparatus so as to display the image data on the display screen,
receive, as natural language text or operation information, a modification request from the user for the image data displayed on the display screen, update at least one of the design specification information and the instruction sentence based on the modification request, and perform a regeneration process by the generative model using an updated instruction sentence in a repeatable manner, and
store, in the storage apparatus, a final version of the image data approved by the user and an association among the final version of the image data, the instruction sentence used for generating the final version of the image data, and model operation conditions.

### Supplementary 2

The system according to supplementary 1,
wherein the processor is configured to
analyze, as learning data, past approval results by the user and corresponding emotion state information and feature information, and adjust weighting or priority applied to the design specification information based on an analysis result of the learning data so as to dynamically optimize contents of generation of the instruction sentence including the prompt sentence for future generation processing.

### Supplementary 3

The system according to supplementary 1,
wherein the processor is configured to
manage, together with version information, a correspondence between the instruction sentence including the prompt sentence and the image data, and, in response to the modification request from the user, generate a new instruction sentence with reference to past instruction sentences and past image data on the basis of the version information and input the new instruction sentence to the generative model, thereby generating and displaying a plurality of design proposals that are changed stepwise.

What is claimed is:

1. A system comprising:
circuitry configured to:
receive, via a communication interface coupled to a packet-switched network, character data from a terminal device;
execute natural language processing on the character data to extract feature data indicating at least one of an emotional state attribute and a preference attribute, and generate structured information by mapping the feature data to predefined fields of a data structure stored in a storage device;
construct a prompt data structure by applying template processing to the structured information, the template processing inserting the feature data into a sentence pattern to form an instruction for a generative neural network model;
transmit the prompt data structure to the generative neural network model and obtain, from the generative neural network model, output composition data generated in response to the prompt data structure;
transmit the output composition data to the terminal device via the communication interface for presentation to a user; and
receive, from the terminal device, feedback data comprising at least one of evaluation data and modification request data, update the structured information based on the feedback data by re-executing the natural language processing on the feedback data to extract updated feature data, and construct a refined prompt data structure from the updated structured information for re-submission to the generative neural network model.

2. The system according to claim 1,
wherein the feature data comprises at least an emotional state label, a color tone attribute, and a subject attribute, each mapped to a respective field of the structured information, and the circuitry normalizes synonymous expressions detected in the character data to canonical labels prior to populating the predefined fields.

3. The system according to claim 2,
wherein the circuitry selects the sentence pattern from a plurality of stored templates based on which predefined fields of the structured information contain non-null values, and generates the instruction by concatenating the selected sentence pattern with constraint parameters specifying at least one of a resolution, a style directive, and an output format for the generative neural network model.

4. The system according to claim 3,
wherein the circuitry is further configured to supplement the prompt data structure with inference parameters comprising at least one of a temperature value, a maximum output token count, and a sampling strategy parameter, the inference parameters being selected based on the emotional state label in the structured information.

5. The system according to claim 4,
wherein the modification request data comprises a natural language query specifying a requested change to the output composition data, and the circuitry extracts, from the natural language query, one or more updated attribute values and merges the updated attribute values into the structured information without re-processing attribute values that remain unchanged, thereby constructing the refined prompt data structure by incremental update rather than full re-extraction.

6. The system according to claim 5,
wherein the circuitry is further configured to store, in the storage device, the output composition data in association with identification information, the prompt data structure, and the structured information, and to index the stored records by the feature data to enable retrieval of previously generated output composition data matching a subsequent set of feature data without re-invoking the generative neural network model.

7. The system according to claim 1,
wherein the circuitry is further configured to analyze the character data to extract product attribute data and category data corresponding to the emotional state attribute and the preference attribute, generate a prompt data structure that includes an instruction for the generative neural network model to generate item proposal data based on the product attribute data and the category data, and specify at least one of an output format and a quantity of proposals in the prompt data structure.

8. The system according to claim 7,
wherein the circuitry is further configured to convert item proposal data received from the generative neural network model in natural language form into structured record data by segmenting the item proposal data into individual items and mapping each item to a record comprising at least an item identifier field and a description field, and transmit the structured record data to the terminal device.

9. The system according to claim 8,
wherein the circuitry converts the item proposal data by applying a parsing algorithm that detects item boundaries based on delimiter patterns or numbering sequences in the natural language output, extracts a name portion and a description portion from each detected item segment, and assigns a generated item identifier to each extracted item.

10. The system according to claim 9,
wherein the circuitry is further configured to receive, from the terminal device, a selection signal identifying a selected item from the structured record data, retrieve detailed attribute data associated with the selected item from the storage device, and generate a follow-up prompt data structure requesting the generative neural network model to provide expanded information for the selected item.

11. The system according to claim 1,
wherein the circuitry is further configured to transmit the prompt data structure to the terminal device prior to submission to the generative neural network model, receive, from the terminal device, a corrected version of the prompt data structure edited by the user, and determine the corrected version as a final prompt data structure for input to the generative neural network model.

12. The system according to claim 11,
wherein the natural language processing extracts syntactic information, semantic information, and sensitivity-related information from the character data, and the circuitry generates the prompt data structure by incorporating visual expression elements, color scheme elements, and composition elements derived from the sensitivity-related information.

13. The system according to claim 12,
wherein the circuitry is further configured to present the prompt data structure as an editable text field on the terminal device, receive iterative edits from the user, and re-generate the output composition data using each successively edited prompt data structure until the user provides a confirmation signal.

14. The system according to claim 1,
wherein the circuitry is further configured to perform emotion analysis processing on emotion-related data received from the terminal device to generate emotion state data, integrate the emotion state data with the feature data to produce specification data, and operate a first generative neural network model using the specification data to generate an intermediate instruction sentence, and provide the intermediate instruction sentence to a second generative neural network model to generate visual content data.

15. The system according to claim 14,
wherein the circuitry is further configured to store the visual content data in the storage device together with the intermediate instruction sentence and model operation conditions comprising at least the inference parameters and a version identifier, and maintain version-linked associations between successive iterations of the visual content data to enable retrieval of any prior version.

16. The system according to claim 15,
wherein the circuitry is further configured to analyze past approval results by the user together with corresponding emotion state data and feature data as learning data, and adjust weighting applied to the specification data based on the learning data to optimize contents of future prompt data structures generated by the first generative neural network model.

17. The system according to claim 16,
wherein the circuitry is further configured to, in response to a modification request from the user, generate a new intermediate instruction sentence with reference to past intermediate instruction sentences and past visual content data retrieved based on the version-linked associations, and provide the new intermediate instruction sentence to the second generative neural network model to generate a plurality of stepwise-varied visual content proposals.

18. A system comprising:
circuitry configured to:
receive character data from a terminal device via a communication interface coupled to a packet-switched network;
execute natural language processing on the character data comprising tokenization, tagging, and classification to extract feature data comprising an emotional state label, a color tone attribute, and a subject attribute;
generate structured information by mapping the feature data to predefined fields and normalizing synonymous expressions to canonical labels;
select a template from a template storage based on populated fields of the structured information, and construct a prompt data structure by inserting the feature data into the selected template and appending inference parameters;
transmit the prompt data structure to a generative neural network model and obtain output composition data;
store, in a storage device, the output composition data in association with the prompt data structure, the structured information, and identification information, the stored records being indexed by the feature data; and
receive feedback data from the terminal device, incrementally update the structured information based on extracted modifications without re-processing unchanged attributes, construct a refined prompt data structure, and re-submit the refined prompt data structure to the generative neural network model.

19. The system according to claim 18,
wherein the circuitry is further configured to detect that incoming feature data is similar to previously stored feature data according to a similarity function, and return a previously generated output composition data from the storage device without invoking the generative neural network model.

20. A method comprising:
receiving, by circuitry via a communication interface coupled to a packet-switched network, character data from a terminal device;
executing, by the circuitry, natural language processing on the character data to extract feature data indicating at least one of an emotional state attribute and a preference attribute, and generating structured information by mapping the feature data to predefined fields of a data structure;
constructing, by the circuitry, a prompt data structure by applying template processing to the structured information;
transmitting the prompt data structure to a generative neural network model and obtaining output composition data;
transmitting the output composition data to the terminal device for presentation to a user; and
receiving feedback data from the terminal device, updating the structured information based on the feedback data by re-executing natural language processing to extract updated feature data, and constructing a refined prompt data structure from the updated structured information for re-submission to the generative neural network model.
